(19) United States
(12) Patent Application Publication
(10) Pub. No.: US 2006/0073260 A1
(43) Pub. Date: Apr. 6, 2006

(54) Extruded ingredients for food products

(76) Inventors: Jodi A. Engleson, Minnetonka, MN (US); Michael A. Porter, Maple Grove, MN (US); William A. Atwell, Champlin, MN (US); John M. Zupfer, Mounds View, MN (US)

Correspondence Address: Edward L. Levine, Esq.;Cargill Incorporated, Law Department, P.O. Box 5624, Minneapolis, MN, 55440-5624, US

(21) Appl. No.: 11/232,197

(22) Filed: Sep. 21, 2005

Related U.S. Application Data
(63) Continuation-in-part of application No. 11/086,095, filed on Mar. 21, 2005.
(60) Provisional application No. 60/555,430, filed on Mar. 22, 2004.
(60) Provisional application No. 60/566,228, filed on Apr. 27, 2004.

(51) Int. Cl. A23L 1/20

(52) U.S. Cl. 426/634

(57) ABSTRACT

The present invention is a nutrient delivery system including an extruded fiber source. Extruding fibers causes many changes to the structure and function of the fiber. Many of these changes make it possible to include higher levels of the extruded fiber source in food products, substantially without a concomitant adverse effect on the functional or organoleptic properties of the food product, as compared to using unextruded fiber sources. Some of the changes that occur during the extrusion of a fiber source may affect its affinity for water in the food product. The nutrient delivery system of the present invention can be used to prepare food products that meet US FDA and other regulatory guidelines for food nutrition labeling.

This application claims the benefit of U.S. Provisional Application No. 60/555,430, filed on Mar. 22, 2004, and U.S. Provisional Application No. 60/566,228, filed on Apr. 27, 2004 and is a continuation-in-part of U.S. patent application Ser. No. 11/086,095, filed on Mar. 21, 2005.

### BACKGROUND

Commercial food manufacturers strive to deliver improved food products to the consumer to meet a wide variety of consumer preferences. One such consumer preference is the desire to increase the nutritional value of regularly consumed food products. The desire for highly nutritive food products must also be balanced by the consumer's preference for organoleptically appealing food products. The commercial food manufacturer is faced with the challenge of providing highly nutritive food products which retain acceptable organoleptic properties such as taste, texture, and appearance, and especially those products that can retain the desired organoleptic properties during the shelf life of the food product.

The nutritional value of a food product, therefore, is something about which the commercial food manufacturer wants to inform the consumer through labeling, advertising, and the like. As with other aspects of food labeling, the U.S. Food and Drug Administration (FDA) has issued regulations regarding the health claims that can be made regarding a food product. Among these regulations are regulations that are specific to the level of nutrients delivered by the food product in order to support the claimed health benefit. In other words, in order for a food product to carry an FDA-approved health claim on the product label or other promotional materials, the food product must consistently deliver a nutrient or a combination of nutrients at defined levels per serving.

Bread is a dietary staple to which many nutritional ingredients have been added. Currently, there are commercially available whole wheat breads meeting the FDA heart health claim requirements regarding whole grain content. Whole wheat contains wheat gluten, and therefore tends to have a less adverse effect on the quality of the bread, particularly on the specific volume and texture of the bread, than non-wheat ingredients. There are also 9- and 12-grain breads, and breads designed to deliver specific nutrients or supplements to meet specific dietary needs, and other similar breads. Although these breads contain nutritive ingredients, the level of a specific nutrient, such as protein or fiber, provided per serving generally falls short of the levels required by the FDA regulations for specific health claim labeling. This is because the high level of nutrients required for making an FDA health claim on a product typically have an adverse effect on the quality of the bread, particularly on the specific volume and texture of the bread.

Other products face similar issues when the nutrient content of these products is increased. For example, nutritional bars, such as breakfast bars or energy bars, have grown in popularity as a quick, easy to use source of nutrition for adults and children. There are a wide variety of nutritional bars, such as breakfast bars, energy bars, diet bars, granola and snack bars, and the like, which strive to deliver a high level of nutrition in a ready-to-eat form. Other nutritive products include cookies, shelf-stable pastries and similar products. However, the level of nutritive ingredients, such as protein, that can be added to these nutritive products is significantly limited by the premature firming such ingredients cause in the products. The premature firming drastically reduces the consumer acceptability of these products over time, even though the actual shelf life (based on the microbial stability of the products) is much longer. As a result, manufacturers of nutritional bars and similar products have been limited in the amount and types of protein that can be included in a formulation in an attempt to delay firming and thereby increase the time period of consumer acceptability of these nutritive products.

### SUMMARY OF THE INVENTION

The present invention is directed to a nutrient delivery system for food products. The nutrient delivery system functions to provide a high level of nutrients to a food product, without substantially adversely affecting properties of the food product. The nutrient delivery system includes an extruded and ground protein source. The nutrient delivery system of the present invention may alternatively or additionally include a fiber source.

The nutrient delivery system of the present invention is made by extruding a protein source, a fiber source, or a combination of a protein source and a fiber source, through an extruder, to alter the structure of the protein, and if present, the fiber. The extrudate is then ground to a fine particle size. The extruded and ground nutrient delivery system is then added to other ingredients to prepare the food product.

The nutrient delivery system of the present invention is useful in methods of reducing serum cholesterol and triglycerides, and can be used to increase the satiety index of food products, while maintaining the pleasing organoleptic properties of the food product.

### DESCRIPTION OF THE DRAWINGS

FIG. 1 shows unpolarized FTIR spectra for unextruded soy protein concentrate.

FIG. 2 shows unpolarized FTIR spectra for extruded soy protein concentrate.

FIG. 3 shows fluorescence spectra of ANS-labeled extruded and unextruded soy protein isolate.

FIG. 4A shows side, end and cross-sectional views of a loaf of bread made with extruded soy protein concentrate.

FIG. 4B shows side, end and cross-sectional views of a loaf of bread made with unextruded soy protein concentrate.

FIG. 5A shows side, end and cross-sectional views of a heart healthy bun made with soy grits.

FIG. 5B shows side, end and cross-sectional views of a heart healthy bun made with extruded soy protein isolate.

FIG. 6A shows side, end and cross-sectional views of a loaf of bread made with extruded whey protein isolate.

FIG. 6B shows side, end and cross-sectional views of a loaf of bread made with unextruded whey protein isolate.

FIG. 6C shows side, end and cross-sectional views of a loaf of bread made with extruded soy protein isolate.

FIG. 6D shows side, end and cross-sectional views of a loaf of bread made with unextruded soy protein isolate.

FIG. 7A shows side, end and cross-sectional views of a another embodiment of a loaf of bread made with unextruded soy protein isolate.

FIG. 7B shows side, end and cross-sectional views of another embodiment of a loaf of bread made with extruded soy protein isolate.

FIG. 8A shows side, end and cross-sectional views of a loaf of bread made with unextruded soy protein isolate and wheat bran.

FIG. 8B shows side, end and cross-sectional views of a loaf of bread made with extruded soy protein isolate and wheat bran.

FIG. 9 is a plot of hardness over time, showing the effects of adding extruded protein on nutrition bar product firmness over time.

FIG. 10 is a plot of hardness over time, showing the effects of various levels of extruded protein on nutrition bar product firmness over time.

FIG. 11A is a plot of hardness over time, demonstrating the ability to increase the total protein level by adding extruded protein, without a concomitant increase in firmness over time.

FIG. 11B is a plot of hardness over time, demonstrating the effects of increasing the extruded protein content of a high protein bar product.

FIG. 12 is a plot of hardness over time of various unextruded proteins.

FIG. 13 is a plot of hardness over time for a product made with 100% extruded protein and a control product made with 100% unextruded protein.

FIG. 14 is a plot of hardness over time for a product containing a blend of extruded and unextruded protein and for a product containing an elevated amount of extruded protein.

FIG. 15 is a plot of hardness over time for products containing a blend of extruded protein, unextruded protein, and monocalcium phosphate.

FIG. 16 is a plot of hardness vs. percent added soy protein isolate for bars made with unextruded powdered soy protein isolate and with extruded and ground soy protein isolate, 23 hours after mixing the bar doughs.

FIG. 17 is a plot comparing the firmness of bar doughs containing extruded and ground protein and fiber to bar doughs containing unextruded, powdered protein and fiber.

FIG. 18 is a plot of firmness over time for bar products containing various blends of extruded protein and fiber and unextruded powdered protein and fiber.

FIG. 19 is a plot of the bar model hardness ratio of bar products versus. the packed bulk density ratio of the extruded fiber ingredients used to make the bar products.

FIG. 20 is a plot of the bar model hardness ratio of bar products versus the packed bulk density of the extruded fiber ingredients used to make the bar products.

FIG. 21 is a plot of the bar model hardness ratio of bar products versus the swelling ratio of the extruded fiber ingredients used to make the bar products.

### DETAILED DESCRIPTION

The present invention is directed to the unexpected discovery that by altering the structure of certain ingredients, the altered ingredients can be used in greater amounts to increase the nutritional value of food products, without substantially adversely affecting the organoleptic properties of these food products. As used herein, the term “organoleptic properties” shall refer to properties of food and beverage products that can be sensed by the consumer.

Food ingredients can be altered in many ways to affect their structure. Extruding the ingredient though a conventional extruder is one way to alter the structure of an ingredient. Extrusion processes involve pumping an ingredient through an extrusion nozzle under high pressure and at an elevated temperature. As will be described herein, extrusion causes many advantageous structural changes that enable an ingredient to be used successfully in greater quantities than previously thought possible, substantially without adverse effects on the food product.

Other techniques can be used to alter the structures of ingredients in accordance with the present invention. Such techniques include, but are not limited to: hydrolysis, enzymatic conversions, drying methods like oven, spray, drum and ring drying, boiling in solution, substitution or addition of functional groups, crossbonding polymer chains, and creating branch points and side chains in polymers.

Protein

It has been unexpectedly discovered that by altering the secondary structure of proteins, an increased amount of protein can be added to a food product without the usual concomitant deterioration of the quality of the food product. It is believed that altering the secondary structure of protein ingredients causes the protein to become relatively inert to its surrounding environment, as compared to the protein in its unaltered state. As used herein, the terms “inert,” “substantially inert,” and “relatively inert” shall refer to the protein becoming substantially less reactive to chemical and physical environments in which the unaltered form of the protein would readily interact with the chemical or physical environment.

Because altering the secondary structure of a protein to reduce the overall amount of ordered structures renders the protein relatively inert, the altered protein can be added in greater amounts to food products substantially without adverse effects to the food product.

In one embodiment of the present invention, soy protein is extruded through a conventional extruder, and an FTIR-ATR (Fourier Transform Infrared-Attenuated Total Reflectance) unpolarized spectroscopic analysis was done to observe the effects of extrusion on the secondary structure of the protein. 20 milligram samples of each of unextruded soy protein concentrate and extruded soy protein concentrate were loaded onto a Digilab FTS 7000 spectrophotometer, available from Varian (Randolph, Mass.). The 1580 to 1750 cm⁻¹ region of each of the FTIR spectra was used to quantify the relative amounts of secondary structure in the extruded and unextruded protein concentrates. This region includes a convoluted group of amide carbonyl absorptions that are sensitive to various types of protein secondary structure. The group is known collectively as the Amide I band, which normally occurs between 1600 cm⁻¹ and 1700 cm⁻¹.

By making certain assumptions regarding the approximate number and frequency positions of these peaks, the overall absorption intensity in this spectral region can be assigned to different protein secondary structures that have characteristic amide carbonyl absorptions. Previous work using well-known pure proteins and theoretical peak frequency calculations has established frequency “windows” for the major types of secondary structure. Based on this, it can be assumed that β-sheet structures show a major absorption peak around 1630 cm⁻¹ along with a smaller peak at 1690 cm⁻¹. α-helix structures absorb around 1650 cm⁻¹, random coil structures absorb throughout the Amide I region, but show the largest intensities around 1660 cm⁻, and β-turns associated with the folding of β-sheets back upon each other absorb most around 1690 cm⁻¹. Since the β-turns and minor β-sheet peaks absorb at virtually the same position and are usually small compared to the other secondary structure absorptions, these turns and sheets are both assigned as “β” structures herein.

In addition to defining the approximate peak positions of these “pure” secondary structures, past work has shown that the widths of these peaks are usually around 25 cm⁻¹. These assumptions of frequency position and peak width are used as initial guesses in an iterative procedure to reproduce the shape of each sample's spectral data. In addition to the four absorption features mentioned above, two other peaks are included to account for the contributions to the 1600 cm⁻¹-1700 cm⁻¹ regions of the protein Amide II band centered around 1525 cm⁻¹ and a residual lipid carbonyl band centered around 1730 cm⁻¹. These contributions are subtracted from the Amide I intensity prior to calculating secondary structure contributions.

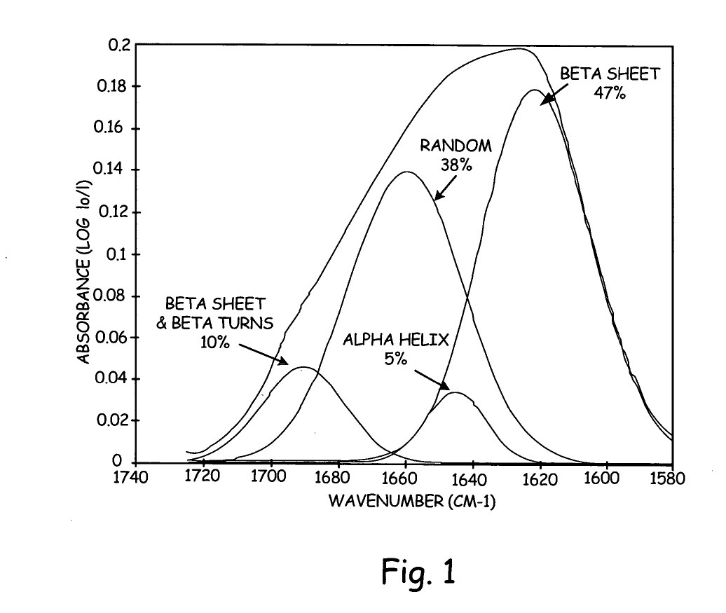

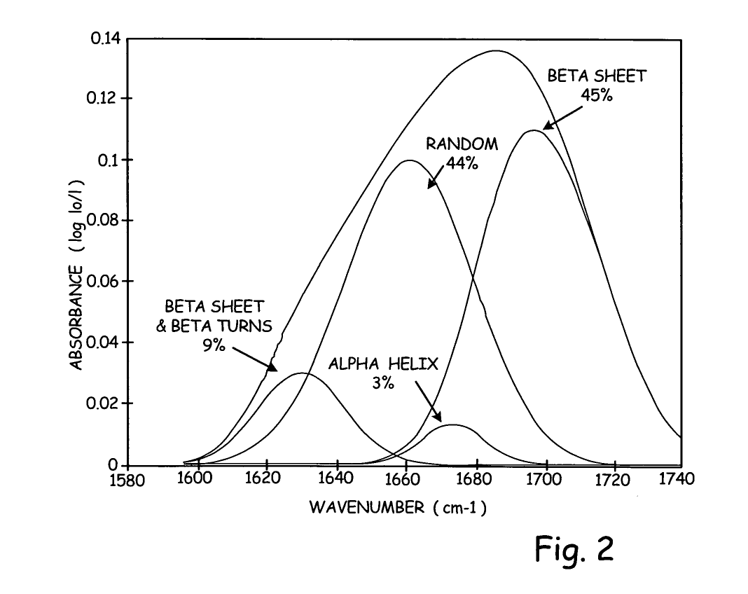

The actual peak calculations are done via non-linear least squares fitting of the hypothetical pure secondary structure absorptions to the actual FTIR spectra between 1580 cm⁻¹ and 1750 cm⁻¹. First, each spectrum is fit with relatively broad constraints on the position and width of the 4 secondary structure peaks and 2 interference peaks. The positions are constrained to ±5 cm⁻¹ around the centers described above, and the widths are constrained to between 15 cm⁻¹ and 40 cm⁻¹. The mean and standard deviation for the positions and widths of each of the 6 peaks are calculated from the fit results on the spectra, and these are used to estimate new constraints for another fit iteration. These constraints are supplied as mean±standard deviation for the positions and widths. The results of this iteration are used to calculate new means and standard deviations, the fit is repeated, and this cycle continued until the peak positions and widths fail to significantly change more than ±1 cm⁻¹ between iterations (in the embodiment shown in FIGS. 1 and 2, this required 5 iterations to achieve). The final set of 6 peaks is then fitted to each spectrum in turn by adjusting only the intensities of the peaks. In this way, peak areas can be calculated consistently for all of the spectra. These peak areas are then converted to relative peak areas by dividing each peak area for a given spectrum by the total intensity of that spectrum, and these fractions are used to quantify the secondary structures present in the soy protein concentrates.

FIGS. 1 and 2 show the spectra for unextruded soy protein concentrate and extruded soy protein concentrate, respectively, and the data are summarized in Table 1.

TABLE 1

| | | | Random |
|---|---|---|---|
| Ingredient | β-sheet + β-turns | α-helix | Coil |
| Unextruded soy protein concentrate | 57% | 5% | 38% |
| Extruded soy protein concentrate | 54% | 3% | 44% |
| Relative change upon extrusion | −5% | −40% | +16% |

As can be seen, there is a marked decrease in the more ordered α-helix and β-pleated sheet and β-turn structures, and an increase in the random coil structures, of the soy protein after extrusion.

The decrease of a protein's ordered secondary structure useful in the present invention ranges from about a 2% to about a 90% decrease in ordered secondary structure, preferably from about a 5% to about a 70% decrease in ordered secondary structure, and more preferably from about a 10% to about a 60% decrease in ordered secondary structure.

The increase of a protein's random secondary structure useful in the present invention ranges from about a 5% to about a 100% increase in random secondary structure, preferably from about a 7% to about a 60% increase in random secondary structure, and more preferably from about a 10% to about a 25% increase in random secondary structure.

In one embodiment of the present invention, a soy protein concentrate extruded in accordance with the present invention preferably shows about a 2-10% decrease in β-structures, about a 20-60% decrease in a-helical structures, and about a 10-25% increase in random coil structures.

In another embodiment of the present invention, a soy protein isolate extruded in accordance with the present invention preferably shows about a 3-10% decrease in β-structures, about a 4-30% decrease in a-helical structures, and about a 5-20% increase in random coil structures.

With the loss of ordered secondary structures in the extruded protein, there is an increase in surface hydrophobicity of the protein, presumably due to the disruption of the protein's hydrophobic core. It is believed that this increased surface hydrophobicity renders the extruded protein relatively inert, so that greater amounts of the protein can be added to a food product substantially without adverse effects on the quality of the food product.

Relative surface hydrophobicity of proteins can be assessed using the fluorescent dye, 1-anilinonaphthalene-8-sulfonate (ANS). ANS is only weakly fluorescent by itself in aqueous media, but becomes relatively highly fluorescent as it binds to hydrophobic regions of protein in water at a neutral pH. In addition, the wavelength of maximum ANS fluorescence also changes depending on how hydrophobic a particular region is. The fluorescence of ANS bound to a more hydrophobic protein moiety will be blue-shifted compared to the fluorescence of ANS bound to a less hydrophobic moiety.

To demonstrate one embodiment of the present invention, separate 1.00% wt/wt solutions of an unextruded soy protein isolate and an extruded soy protein isolate in 1M tris buffer (pH=7.5) were prepared by vortexing. 1.00 mL aliquots of these solutions were centrifuged to separate undissolved material, and 100 μL of each supernatant was then diluted in 3.00 mL tris buffer in a methacrylate fluorimeter cuvette. 50 μL of a 0.67 μM solution of 1-anilinonaphthalene-8-sulfonate (ANS; Molecular Probes Inc., Eugene, Oreg.) was added to this diluted soy protein solution, and this combination was allowed to react for five minutes with stirring. After this five-minute labeling period, the fluorescence emission spectrum of each solution was collected over 375-650 nm, integrating for 0.1 sec at 1 nm increments, using a JY/Horiba Fluoromax-3 fluorimeter (Jobin Yvon, Inc., Edison, N.J.). Excitation and emission bandpasses were 5 nm. The absorbances at 280 nm of identically-prepared dilutions of the two protein samples were determined using a J&M diode-array spectrophotometer with a deuterium lamp (J&M GmbH, Aalen, Germany). A solution of tris buffer without soy protein isolate served as the blank.

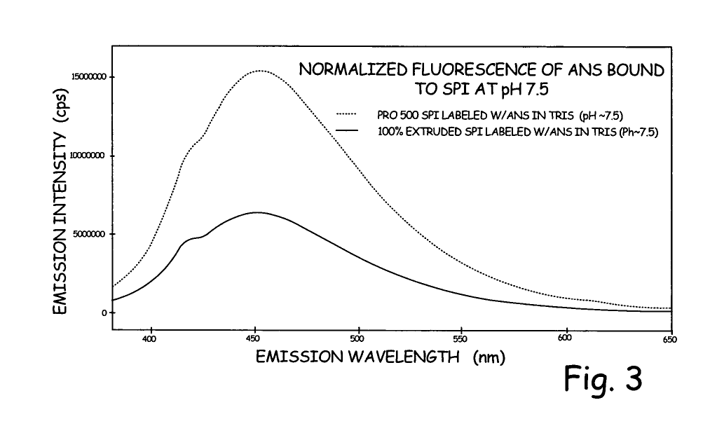

The fluorescence spectra are shown in FIG. 3. As can be seen, there is a significant increase in emission intensity in the extruded protein sample compared to the unextruded sample. By measuring the peak and the area of the emission profiles, the relative increase in surface hydrophobicity upon extruding or otherwise altering a protein can be determined.

Using this method, a relative increase in surface hydrophobicity of at least about 20% is usefuil in the present invention. Preferably, the surface hydrophobicity increases by at least about 23%, and more preferably, the surface hydrophobicity increases by at least about 25%, as compared to the surface hydrophobicity of an unextruded or otherwise unaltered protein.

While not intending to be limited by theory, it is believed that the hardening of bars and other high protein, low moisture products is caused by the formation of ordered domains over time. These domains are formed due to the ordered α-helical and β-sheet structures in the proteins. In the extruded protein ingredient of the present invention, the reduction of these ordered structures and the increase in the amount of random coil structures causes fewer ordered domain regions to form, so the bar remains softer over time. In addition, the increased surface hydrophobicity of the extruded protein ingredient is also believed to hinder ordered domain formation, since water is believed to be the prerequisite to changes in the tertiary structure of the proteins which result in the formation of ordered domains.

As described previously, extrusion is one way to alter proteins in accordance with the present invention. During extrusion, protein strands will align along the extrusion axis. Upon exiting the extruder, the protein strands experience a significant pressure drop, which causes the protein strands to become highly entangled. While not intending to be limited by theory, this entanglement is believed to cause cross-linking across sulfhydryl or other chemical moieties on the protein strands which changes the secondary structure of the protein molecules, as observed by spectroscopic changes, and which suppresses protein strand mobility and interactivity, as observed by an increase in glass transition temperature.

Glass transition temperature, or Tg, represents the transition temperature of an amorphous solid material from a hard, glassy state to a softer, rubbery state. Typical glass transition temperatures for proteins range from about 130° C. to 200° C. at 0% moisture. As the protein is exposed to increased levels of moisture, the Tg decreases. It has been surprisingly discovered that an extruded protein in accordance with the present invention, such as an extruded soy protein isolate, has a glass transition temperature ranging from about 290° C. to 300° C. at 0% moisture.

The increase in the glass transition temperature of the extruded protein signifies that the protein strands are substantially less mobile, so the extruded protein remains relatively less reactive over a wide range of temperatures and moisture levels. The extruded protein, therefore, does not significantly interact with its chemical or physical environment as compared to an unextruded protein having a lower glass transition temperature, so greater amounts of the extruded protein can be added to a food product, substantially without deleterious effects.

As the moisture level of a particular food system increases, such as during the mixing of dry ingredients with water, the extruded protein may remain relatively less reactive for a longer period of time due to its higher Tg than an unextruded protein, thereby delaying and reducing the interaction between the protein and the remaining ingredients in the food product.

In one embodiment of the present invention, the extruded protein has a glass transition temperature that is about 50% greater than the glass transition temperature of the unextruded protein. Preferably, the extruded protein has a glass transition temperature that is about 75% greater than the glass transition temperature of the unextruded protein. More preferably, the extruded protein has a glass transition temperature that is about 80% greater than the glass transition temperature of the unextruded protein.

Protein sources suitable for use in the present invention include any protein source suitable for use in food products, such as, but not limited to, proteins from plant, animal and dairy sources. These proteins can be in any form suitable for structural alteration, such as by extrusion, to render the proteins relatively inert and suitable for inclusion at high levels in food products substantially without deleterious effects on the food product.

One example is soy protein, which can be used in any form, such as soy protein concentrate obtained by removing aqueous alcohol- or acid-soluble non-protein components from soybeans, and which has a protein level of about 70% on a dry basis, or soy protein isolate obtained by removing the protein fraction of soybeans from other soybean components, which has a protein level of about 90% on a dry basis. Other forms of soy protein suitable for use in the present invention include soy grits and soy flour, each of which has about 50% protein on a dry basis.

Other protein sources include, but are not limited to: vital wheat gluten, whey protein isolate, soy, whey, casein, gluten, and the like.

Protein sources, such as protein isolates, concentrates, flours, flakes, or grits, contain protein that is partially to completely denatured from the native state. In the context of the present application, the native state is intended to indicate the original, natural protein structural order at secondary, tertiary and quaternary levels of organization and is expressed at the individual protein level.

Protein ingredients may differ in degree of denaturation as a result of differing distributions of native and denatured proteins in a mixture. Denaturation can occur at one level of organization without effecting the order at other levels of organization; for example, denaturation may not change the primary sequence of the protein. The denaturation occurs during the extraction, separation or pasteurization of the protein from its original source, such as soybeans or milk. However, the degree of denaturation resulting from these processes (the degree of disorder at the relevant levels of structural organization) is not sufficient to significantly alter the ability of the protein to interact with its environment, as evidenced by the control (unextruded) data in the examples shown below.

In a number of cases, the unextruded materials would be considered to be completely denatured by most standard measures. The present invention is directed to further altering the protein structure by increasing the level of total disorder in a protein ingredient by extrusion to render the protein relatively inert as compared to the unextruded protein.

Fiber

Fiber is another nutrient that food manufacturers strive to increase in food products, but which typically has deleterious effects on the food product. Fiber is generally divided into two categories, soluble and insoluble, based on the solubility of the fiber in water at room temperature. Increasing soluble fiber intake improves intestinal and overall health by providing nutrients to intestinal flora. Insoluble fiber promotes overall health by providing indigestible bulk to food products.

However, the addition of high levels of fiber, particularly insoluble fiber, to food products is known to adversely affect the organoleptic properties of these food products. High fiber food products can have a dry, tough, chewy, or dense texture, making them less appealing to consumers.

It has been surprisingly discovered that by extruding a fiber source, the fiber is structurally altered to an extent that reduces or eliminates many of the deleterious effects fiber typically has on a food product. Preferably, the fiber is coextruded with a protein source, to produce a protein-fiber ingredient that can be added in greater amounts as compared to an unextruded or otherwise untreated fiber ingredient.

Using FTIR-ATR spectroscopy, it has been determined that extrusion causes changes in conformational order in carbohydrate fiber sources. In general, molecular vibrations in carbohydrates are sensitive to changes is conformational order. Specifically, as a carbohydrate becomes more disordered, infrared bands broaden with a concurrent loss of fine structure, that is, a loss of band resolution. Within a set of ordered carbohydrate molecules with the same conformation, the molecules exist in relatively similar molecular environments and thus produce infrared bands within a fairly narrow frequency range. Since disordered carbohydrate molecules can exist with different conformations, the molecules exist in a variety of molecular environments. For this reason, the disordered molecules produce a manifold of infrared bands with slightly different frequencies. A band associated with one specific conformation is too broad to be resolved in a condensed phase infrared spectrum; thus the apparent result is a broader, less defined band. Under controlled conditions these spectral features can be used to qualitatively monitor changes in conformational order.

In accordance with the present invention, extrusion of a fiber source alters the structure by changing the conformational order of the fiber compared to the unextruded fiber. The alterations in structure are best observed in the set of intense infrared bands observed for all carbohydrates in the 1200 to 900 cm⁻¹ region of the infrared spectrum, which is commonly referred to as the “C—O stretch region”. An extruded fiber of the present invention will have a broader, less defined band in this C—O region than its unextruded counterpart. These conformational changes are believed to reduce or eliminate the ability of the fiber to deleteriously interact with its environment in the food product, thereby allowing the inclusion of greater amounts of fiber in the food product substantially without the concomitant adverse effects on the organoleptic properties of the food product.

When any ingredient is introduced to a food system, the ingredient may impact the system's behavior in three possible ways. The ingredient will have a direct effect on the food's characteristics through its own properties. The ingredient will have an effect on other ingredients' properties through its interaction with those ingredients. Finally, the ingredient will have an effect on the system's properties through its competition for mobile components in the system. In a bread product, for example, an added fiber directly changes the texture of the crumb and interacts with starch and protein molecules and competes with other materials for the available water. Extrusion may change the properties of a fiber in ways that affect any or all of these three mechanisms. Different fibers or combinations of fibers may operate differentially through these three mechanistic categories.

While not intending to be bound by theory, it is believed one possible mode of action is that the conformational changes to the fiber structure that occur upon extrusion can decrease the hydrophilicity of the fiber, causing the fiber source to be less interactive with the moisture in the product to which the fiber is added. As a result, moisture migration into the fiber source is reduced, and the product retains its desirable organoleptic properties, such as softness and tenderness, for a greater period of time. This mode of action would be representative of a change in competition for a mobile system component.

The American Association of Cereal Chemists defines dietary fiber as the edible parts of plants or analogous carbohydrates that are resistant to digestion and absorption in the human small intestine with complete or partial fermentation in the large intestine. As used herein, the terms “fiber,” “fiber source,” “dietary fiber” and “dietary fiber source” shall also refer to non-digestible oligo- and polysaccharides.

Because of the nature of fibers, which are mostly carbohydrates, there can be a great degree of variation on the effects of extruding a fiber source, depending on the relative degree of crystalline (highly ordered) or amorphous (more random) character of the carbohydrate. If the starting material has a higher level of amorphous domains, extrusion may cause an increase in the amorphous phase, rendering the fiber more hydrophilic. If the starting material has a lower level of crystalline domains, extrusion may cause an increase in the crystalline phase, rendering the fiber less hydrophilic. Those skilled in the art will appreciate, based on the present invention, that the extruder conditions may also affect the outcome, and that these conditions may be varied to achieve the desired result based on the starting materials.

For example, if the starting material is more crystalline, extrusion may cause the removal of exposed soluble portions of the fiber, so the resulting extruded fiber may be less hydrophilic. Another example is if the starting material is partly crystalline, the extrusion temperature may cause the crystalline regions to melt and then reform upon exiting the extruder, so there may be an increase in the crystalline domain, resulting in a net decrease in hyrophilicity.

Within the amorphous state, polymers can exist in glassy (rigid) or rubbery (flexible) phases. In general, if extrusion causes a net increase in and alignment of crystalline or glassy domains in the carbohydrate, the kinetic hydrophilicity of the fiber source decreases due to lack of local polymer mobility, and the less interactive the fiber source is to its surrounding product environment. Conversely, if extrusion causes a net increase in the rubbery amorphous character of the carbohydrate, the resulting fiber source will have a greater kinetic hydrophilicity and may adversely effect the surrounding product environment by absorbing more water.

It is believed that extrusion can significantly change the crystalline and glassy fractions in some carbohydrate polymers. This can result in a sequestration of potential hydrophilic domains and consequently a decrease in measurable hydrophilicity. As in the case of proteins, extrusion may cause conformational changes that result in an increase in exposed hydrophobic regions. As a result, extruding a protein-fiber blend causes an overall decrease in hydrophilicity, making the blend less interactive or reactive to its environment.

The overall decrease in hydrophilicity as a result of the increase in crystalline and glassy fractions in the polymers may be evidenced in the decrease in the water activity of the carbohydrate upon extrusion. Water activity, or a_{w}, is defined as the vapor pressure of water divided by that of pure water at the same temperature. Therefore, pure distilled water has a water activity of exactly one. Water activity can be distinguished from water retention or absorption since water activity is dependent on a particle's affinity for water, not just its capacity to absorb water. For example, two ingredients may have the same water content, but may have differing water activities under the same conditions. Other methods of assessing the decrease in hydrophilicity include apparent viscosity, particle swelling, infrared spectroscopy, and X-ray diffraction.

It was surprisingly discovered that although extruded fiber ingredients of the present invention generally had lower water activities and lower moisture contents than the unextruded fiber, some of the extruded fiber ingredients behaved as if they were more plasticized than the unextruded fiber. As will be described below, the extruded fiber ingredients actually swelled more and attained a higher viscosity in excess water than the unextruded fiber.

Extrusion also causes changes in the amount of dietary fiber, both soluble and insoluble, that are available from a carbohydrate source, and these changes can be quantified using conventional techniques.

Although the embodiments described herein utilize extrusion to decrease the overall hydrophilicity of carbohydrates, other methods are contemplated by the present invention to achieve the same result. Such methods include using additives to reduce the amount of starch gelatinization during extrusion.

Another possible mode of action that occurs upon extruding polysaccharides or proteins is the increased degree of polymer entanglement that is achieved upon extrusion. Polymer chain entanglement describes the relative translational immobility of polymer chains, such that they cannot move through one another. Polymer chain entanglement theory also relates to behavior characterized by the glassy and rubbery states, as the entangled polymers cannot form crystalline domains. Depending on the concentrations of plasticizer molecules in the system, the interactions between the plasticizers and the polymers, and the system temperature, the entangled polymers can contribute greater or lesser effects to the food texture. For example, if an extruded composition has a higher percentage of its composition in the rubbery state at a given moisture and temperature than is typical of the unextruded composition, then the extruded composition will impart a softer texture on the product than the unextruded composition. This is an example of a direct effect of the introduced ingredient on the food system.

It is believed that extrusion causes a significant increase in polymer chain entanglement. This increase in entanglement may be due to flow along the extrusion barrel, turbulence due to reverser elements, and the pressure drop at the extruder die exit face. One further consequence of the chain entanglement theory is that polymers entangled together lose their translational mobility. Consequently, the polymers lose much of their ability to directly interact with components in the food system. To the extent that the unextruded composition caused negative effects through such interactions, chain entanglement has a positive effect through preventing undesirable interactions. This is an example of the introduced ingredient having a different effect on the performance of other ingredients.

A third possible mode of action that occurs upon extruding fiber ingredients may occur due to an increase in the particle density of the fiber source. The more dense particles occupy less volume in the product and have a smaller surface area than the unextruded fiber source. Therefore, more of the extruded ingredient may be added without adverse effects on the product, since the higher density extruded products have a smaller surface area and therefore do not interact with the product environment as much as the unextruded ingredient.

It was surprisingly found that although the particle density increased, these same particles absorbed more water and attained a higher viscosity than the unextruded control. It was therefore unexpected that these extruded fiber particles that apparently absorbed more water were not as interactive with the product environment and could be added to the low moisture products to result in a significantly softer product.

Without intending to be bound by theory, it is believed that multiple mechanisms are taking place to cause these phenomena to occur. One possible mechanism is that because the extruded particles are more dense, they are capable of absorbing more water or other plasticizer than the unextruded particles, so the extruded ingredient becomes softer as the product formulation is being prepared, resulting in an overall softer product. The unextruded fiber occupies more volume but absorbs less water than the extruded fiber source, resulting in a significantly harder dough.

Another possible mechanism, as mentioned above, is that because the extruded particles are more dense, they occupy less volume than the unextruded fiber, so there is more volume available for the syrup, which remains more plastic, resulting in a softer product.

These mechanisms may occur simultaneously and independently of one another, or they may occur in series, so that the extruded particles begin as more dense, lower surface area particles (compared to the unextruded fiber), but as the ingredients are mixed or as the products are stored over time, the extruded fiber absorbs more moisture and becomes more plasticized than the unextruded fiber. Any combination of mechanisms is contemplated by the present invention.

A fiber ingredient in accordance with the present invention may contain 100% extruded fiber, preferably at least about 50% extruded fiber, and more preferably at least about 70% extruded fiber. The extruded fiber may be provided as an ingredient in combination with unextruded fiber or with an unextruded or an extruded protein.

In one preferred embodiment of the present invention, the fiber source is preferably coextruded with a protein source to produce an extruded protein-fiber ingredient having a protein and fiber content ranging from about 85% protein and 15% fiber to about 15% protein and 85% fiber, all percentages given by weight. In one embodiment, the protein and fiber are coextruded to provide an ingredient comprising 30% by weight protein, and 70% by weight fiber. In another embodiment, the protein and fiber are coextruded to provide an ingredient comprising 70% by weight protein, and 30% by weight fiber.

The extruded protein-fiber ingredient of the present invention may be used in a food product to increase its protein and fiber content substantially without the typical deleterious effects on a food product associated with the addition of unextruded fiber or unextruded protein.

Fiber sources suitable for use in the present invention include, but are not limited, to any variety of plant-derived, microbially-derived or animal-derived fiber. Examples of suitable fiber sources include cereal bran, cereal aleurone, oilseed hulls, purified cellulose, derivatized cellulose, inulin, arabinoxylans, gums, β-glucans, alginates, agar, arabinogalactan, fructooligosaccharides, modified dextrin, polydextrose, psyllium, chitosan, chitin, resistant starch, and other nondigestible carbohydrates.

Extrusion in the Food Industry

Extrusion for manufacture of foods and food ingredients has long been employed with a wide range of materials. Grains, refined starches and proteins, and many micro-ingredients have been combined in extrusion to produce foods including cereals, pet foods, meat analogs, flavor carriers, and snacks. Extrusion can be used to make food products that have a light, airy and crispy texture. The benefits of extrusion include the ability to obtain a light, airy texture consistently, making extruded food products appealing to consumers.

The basic process involves blending of the dry ingredients in the desired proportions and conveying the dry ingredients to the extruder. The dry ingredients may be directly conveyed or passed through a pre-conditioner where moisture may be added and the mix may be warmed up before entering the extruder. The material is then introduced to the extruder and passed through different zones in the extruder that mix, shear and compress the material. Water or liquid ingredients may be directly introduced into the extruder barrel to mix with the dry ingredients to form a dough. Some extruders are jacketed so that the temperature can be raised or lowered by passing a thermal liquid through the jacket, though many extruders are not jacketed. The screw(s) conveying the material compress the material raising the temperature and “melting” the dough. The rubbery dough is pressed through a die to shape the dough and the dough is cut with some form of rotary knife. The pressure drop that occurs as the dough passes from the high-pressure extruder into the atmosphere can cause a sudden expansion and cooling of the dough as the water boils off. Typically, water is further removed by passing the extruded pieces through a belt oven, fluid bed dryer or some similar drying equipment.

Because of the wide variety of materials, equipment and desired product characteristics involved in extrusion, the present invention encompasses any extrusion method that produces materials that meet the requirements of this invention. For example, both single-screw and twin-screw extruders may be used to form the extruded protein or fiber pieces. Depending on the composition and equipment configuration, the moisture of the product at the interior die face may be from about 15 to about 35% on a dough basis. Temperatures at this same point may be from about 100° C. to about 160° C. Those skilled in the art will know to change the water (or steam) added to the extruder, the feed rate of the dry materials, and optionally the jacket temperature to insure that the resulting product has the desired characteristics of color, density, shape, homogeneity and particle size.

It was unexpectedly discovered by the present inventors that by extruding certain ingredients, such as protein or fiber, to form a crisp, and then grinding the crisp to a flour-like particle size, the ingredients could be added at high levels to food products while avoiding the deleterious effects associated with the use of high levels of these ingredients in an unextruded form. This was unexpected because this process essentially negates the conventionally-known benefits of extrusion by grinding the extruded crisp pieces back into fine particles, in some instances to a particle size smaller than that of the starting materials.

Instead, the present inventors have discovered that the extrusion process alters the structure of food ingredients at the molecular level, and these structural changes permit the inclusion of the extruded ingredients at higher levels, substantially without deleterious effects, than previously thought possible.

In accordance with the present invention, any conventional extrusion apparatus and method can be used. In the embodiments described herein, a moist or wet extrusion process is preferred. Such moist extrusion includes adding steam during the extrusion process, or adding water to the dry ingredients prior to extrusion as described herein.

After the ingredients are extruded, they are dried as needed, using conventional drying means, then ground using any type of conventional mill. Examples of suitable mills include hand mills, automatic kitchen or benchtop mills, and industrial scale mills.

United States Food and Drug Administration Health Claims

The United States Food and Drug Administration (hereinafter, “U.S. FDA” or “FDA”) has promulgated regulations regarding the ability of a food manufacturer to label food products with certain nutritional claims. These regulations are codified in 21 C.F.R. §101 et seq. In order for a food product label to carry an FDA-approved health claim, the food product must consistently deliver a nutrient or a combination of nutrients at defined levels per serving.

The current FDA regulations regarding the protein content of a food product are summarized as follows. In order for a food product to be labeled as an “excellent” source of protein, the food product must contain at least 10 grams of protein per reference amount customarily consumed per eating occasion (RACC). This is 20% of the recommended daily value for protein. To be labeled as a “good” source of protein, the food product must contain at least 5 grams/RACC of protein, which is 10% of the recommended daily value for protein.

Due to the potential role of soy protein in reducing the risk of heart disease, the FDA has promulgated specific regulations regarding the soy protein content of food products. Qualifying foods may be labeled with statements such as “25 grams of soy protein a day, as part of a diet low in saturated fat and cholesterol, may reduce the risk of heart disease. A serving of (name of food) supplies ______ grams of soy protein” or “Diets low in saturated fat and cholesterol that include 25 grams of soy protein a day may reduce the risk of heart disease. One serving of (name of food) provides ______ grams of soy protein.”

In order to meet the FDA's soy protein claim requirements, a food product must contain a specified level of soy protein per RACC. For example, bread must contain 6.25 g soy protein per 50 g serving (the RACC for bread). The food product must also qualify as low in total fat, saturated fat and cholesterol. To qualify as low in total fat and saturated fat, the food must have less than 3 g total fat per RACC, and less than 1 g saturated fat per RACC, with the saturated fat contributing 15% or less of the total calories per serving. Low in cholesterol requires that the 3 g total fat provide less than 20 mg cholesterol per RACC. The food product must also have a limited amount of sodium, preferably less than 480 mg per RACC.

To meet the FDA regulations regarding fiber content, a food product must contain at least 20% of the recommended daily value of fiber, which is 25 g/day, to be labeled as an “excellent” source of fiber, and at least 10% of the recommended daily value of fiber to be labeled as a “good” source of fiber. The food product is also preferably low in fat as defined above.

Food manufacturers are faced with the dilemma of providing highly nutritive food products in accordance with FDA regulations, which also provide desirable organoleptic properties to the consumer in a consistent manner. The nutritive food ingredients of the present invention can help to overcome this dilemma in many food products, examples of which are described herein.

Health Benefits of Soy Protein and Dietary Fiber

As described herein, the U.S. F.D.A. has authorized the use of a health claim related to consumption of soy protein. This claim recognizes that consumption of soy protein may have multiple positive effects on the coronary health of consumers. A meta-analysis of clinical trials (Anderson et al., N. Engl. J. Med. (1995) 333:276-282) showed that consistent consumption of soy protein could lower total serum cholesterol about 9%, low-density lipoprotein cholesterol about 13% and triglycerides about 11%. High-density lipoprotein cholesterol, a preferred form of cholesterol was increased non-significantly. As described in an accompanying article (Erdman, N. Engl. J. Med. (1995) 333:313-315), the primary problem may be in composing foods that contain high levels of soy in sensorially acceptable forms.

Serum lipid metabolism is not the only health condition benefiting from soy protein consumption. Preliminary research indicates that soy protein consumption may be helpful in reducing the risk of developing prostate (Severson et al. Cancer Research (1989) 49:1857-1860), breast (Rose, Nutrition and Cancer (1992) 8:47-51) and gastro-intestinal cancers (Nagai et al., Nutrition and Cancer (1997) 3:257-268). Foods comprising a high concentration of soy protein to be consumed by people who wish to reduce their cancer risk could be developed using the invention described here that would have superior sensorial value and enable higher inclusions in a food serving.

Soy protein consumption has been shown to alleviate some of the symptoms of menopause including night sweats and hot flashes (Nagata et al., Amer. J. Epidemiology 153:790-93). In addition, preliminary research suggests that soy consumption may help maintain bone health in postmenopausal women (Chiechi et al., Maturitas (2002) 42:295-300; Gallagher et al., Menopause (2004) 11:290-298).

Fibers are typically sub-categorized as soluble and insoluble as described above. The two types of fiber are often thought to have different health benefits. Insoluble fibers provide slight viscosity to the intestinal lumen and have a weak effect on recovery of cholesterol and triglycerides from the gut. Consequently, insoluble fiber is thought to have a weak to negligible effect on serum cholesterol and triglycerides. Insoluble fiber does provide a suitable environment for growth of bacteria thought to be beneficial for health. Insoluble fiber reduces the transit time of foods in the intestine and absorbs water, which may reduce the risk of diverticulitis (Aldoori et al., J. Nutr. (1998) 128:714-719) or irritable bowel syndrome. Consumption of insoluble fiber may have a positive satiation effect and thus help curb the tendency to over-eat.

Soluble fibers provide significant viscosity to the intestinal lumen and have a significant effect on cholesterol and triglyceride recovery from the gut. Additionally, soluble fibers may interact with bile salts. Fermentation products derived from intestinal fermentation of some soluble fibers are thought to suppress cholesterol biosynthesis. Consequently, soluble fiber is thought to have a strong effect on reducing serum cholesterol and triglycerides. Additionally, soluble fiber has been shown to have a differential reducing effect on low-density lipoprotein (LDL) associated cholesterol—a less desirable form of cholesterol from a cardiovascular disease risk perspective. Increased soluble fiber consumption is associated with lower serum LDL cholesterol levels.

Many epidemiological and clinical studies have examined the effects of dietary fiber intake on a wide variety of other health conditions. A general consensus has been achieved that diets higher in fiber, relative to conventional western diets, would aid in the development of a healthier population. However, the specific connection between fiber consumption and any particular health condition is not always clear.

It was widely believed that diets high in fiber reduced the risk of colorectal cancer, but some studies have not confirmed this link. However, most evidence from animal trials and numerous human trials have shown that insoluable fiber can have a significant reduction in the risk of developing colorectal cancer (McIntosh, In Dietary Fibre: Bio-active carbohydrates in food and feed, Ed. Van der Kamp, Asp, Miller-Jones and Schaafsma, 2004, Waginingen Academic Publ.; Miller-Jones, In Dietary Fibre: Bio-Active carbohydrates in food and feed, Ed. Van der Kamp, Asp, Miller-Jones and Schaafsma, 2004, Waginingen Academic Publ.). Another example of an unconfirmed link between fiber and health involves a potential benefit regarding improved glycemic control (Schulze et al., Am. J. Clin. Nutr. (2004) 80:348-356; McKeown et al., Diabetes Care (2004) 27:538-546; Jimenez-Cruz et al., Diabetes Care (2003) 26:1967-1970), and improvements in related conditions like metabolic syndrome, insulin resistance and type 2 diabetes development. Cereal fiber may be significantly correlated with improved control, but total dietary fiber may not be (Schulze et al., Am. J. Clin. Nutr. (2004) 80:348-356; McKeown et al., Diabetes Care (2004) 27:538-546). Such complex associations mean that specific dietary recommendations for condition-specific health improvement are pre-mature, but that general recommendations to increase dietary fiber are appropriate.

Enabling consumption of high fiber diets requires a better ability to incorporate fiber into acceptable food products because many high fiber foods are not presently considered acceptable. The invention described herein enables incorporation of higher level of fibers, both soluble and insoluble, to enable consumers to address health conditions through dietary modification.

One of the main health problems in developed countries relates to obesity resulting from over-consumption of high calorie foods. Research (Holt et al., Eur. J. Clin. Nutr. (1995) 49:675-690) has shown that different foods of the same caloric content have very different impacts on an individual's perception of satiety. A strong correlation was shown between the satiation provided by a food and subsequent amounts of food consumption. Breads, sweet baked goods and cereals were shown to have some the lowest satiety effects of tested foods. In contrast, foods high in protein or fiber were shown to have high satiation. Many of the more satiating foods scored lower in palatability indicating that the ability of food manufacturers to deliver highly satiating foods may depend on their ability to provide higher concentrations of fiber and protein in forms that have the visual and sensory properties expected for the food. Consequently, this invention enables creation of foods that can deliver greater satiety to consumers. These foods can be used to help consumers control their food intake and thus help manage their weight.

Bread and Bakery Products

The use of extruded soy protein ingredients in bakery products in accordance with the present invention is preferably balanced so as to ensure that the resulting baked product achieves the desired organoleptic properties in addition to having the desired levels of soy protein, fiber, fat, and other nutrients. Preferably, bread and bakery products made in accordance with the present invention have nutrient levels sufficient to meet one or more FDA nutrient labeling requirements described herein. Currently, the RACC for bread is 50 g per serving.

The properties of bread and other bakery products are predominantly determined by the properties of the dough. The dough properties, in turn, are determined by the dough ingredients and by how the dough is processed. The most basic dough ingredients are wheat flour, water, salt, and a leavening system, such as yeast, chemical leavening agents, or a combination of both yeast and chemical leavening agents.

Upon mixing water with the flour and the leavening system, the flour particles become hydrated, and the shear forces applied by mixing cause wheat gluten protein fibrils from the flour particles to interact with each other and ultimately form a continuous gluten matrix.

Furthermore, as the dough is mixed, air is incorporated in the dough, creating air cells throughout the dough. When carbon dioxide gas is generated by the leavening reaction in the dough, the carbon dioxide first goes into solution. As the water in the dough becomes saturated with carbon dioxide, carbon dioxide being generated by the leavening migrates into the air cells in the dough. The number and stability of the air cells in the dough is determined by the quality of the gluten matrix and the number of air cells initially created during the mixing process.

A well-developed wheat gluten matrix results in a dough that can retain the carbon dioxide generated by the leavening system, and therefore deliver the desired specific volume in the final baked product.

Adding non-glutenaceous ingredients to the dough may interfere with the ability of the gluten to form a continuous matrix during mixing. The non-glutenaceous ingredients may compete for the moisture in the dough, thereby hindering the formation of the gluten matrix. In addition, the non-glutenaceous ingredients may occupy space in the dough and physically limit the gluten-gluten interactions required to form the gluten matrix. Furthermore, the non-glutenaceous ingredients may serve as air cell nucleation sites and may cause large air pockets to form in the dough. Gas generated by the leavening action will preferentially migrate to the air pockets rather than remaining distributed in the smaller air cells that are more evenly dispersed through the dough, creating an undesirable texture in the final bakery product. Therefore, the advantages of adding non-glutenaceous ingredients to the bread, such as high soy protein content ingredients, must be balanced with the deleterious effects such ingredients may have on the gluten matrix, the overall dough structure, and the resulting baked product quality.

In increasing the soy protein content, the dough's rheological properties are monitored to ensure that the dough's characteristics remain within a processable range. By monitoring the Theological properties of the dough accordingly, a dough having a high soy protein content can be made, processed, and baked using the same manufacturing equipment and parameters as a conventional dough.

Bread Quality

The quality of a bakery product can be defined in part by the specific volume of the bakery product. In general, if the specific volume is above a certain level, the bakery product will have the desired texture and appearance. However, there are instances in which a specific volume may be too high, (e.g., the crumb is too open and the bread is not dense enough to be acceptable). The commercial food manufacturer strives to consistently deliver bakery products that achieve the desired specific volume to provide an organoleptically pleasing product that can withstand normal handling conditions. Other quality indicators besides specific volume may include chewiness and hardness of the bakery product and Theological properties of the dough. It has been found that specific volumes of around 3.5 cc/g up to about 6 cc/g often result in the desired bakery product characteristics.

Another useful measurement in evaluating the quality of high protein bakery product of the present invention is by measuring the rheological properties of the dough. Rheological properties of dough products are usually measured by evaluating the viscoelastic properties of the dough. One instrument used to measure the viscoelastic property is the Farinograph. The Farinograph measures the resistance of a dough to mechanical mixing. The resistance is recorded as a curve on a graph. The Farinograph curve provides the useful information regarding the dough strength, mixing tolerance, and absorption (water holding) characteristics of a flour. The resistance is measured in Brabender units (BU).

Another characteristic that affects the bakery product is the particle surface texture of the ingredients. In general, smoother ingredients do not serve as air cell nucleation sites as readily as ingredients with irregular surfaces. The ingredient irregularities provide small pockets of air in the dough that create air cells in contact with or adjacent to the particulate. As carbon dioxide gas enters into these air cells, the cells grow and agglomerate, creating a large cell around or adjacent to the particulate. If these cells are large enough, they may increase the diffusion of gas through the dough and may even cause the dough to collapse, resulting in poor baked product quality.

In some bakery products, the appearance of particulates is desired to give the product a grainy texture, while maintaining the desired specific volume and other attributes. An example of how to provide particulates substantially without a concomitant loss of specific volume and other properties is described in co-pending PCT application number PCT/US04/12289.

In other products, it is desirable to maintain as uniform a texture as possible, such as in sandwich or hot dog buns. In these cases, to increase the nutrient level in the product, an alternative to particulates is needed to maintain the uniform texture. The extruded nutritive ingredients of the present invention are designed to maintain a relatively uniform texture in the food product while providing a high level of nutrients, all substantially without adverse effects on organoleptic properties of the food product.

Bread and bakery products useful for different applications might require specific volumes, rheologies, chewiness, hardness etc. that are different for those bread and bakery products useful for other applications. The present system and method enables the optimization of each of the properties when making the bakery product. One of the examples discussed below shows the creation of a bun using the aspects of the present invention. Other bakery products useful in the present invention include, but are not limited to, rolls, bagels, pretzels, pizza or similar crusts, tortillas, wraps, pita bread, foccacia, English muffins, doughnuts, cakey brownies, and similar bakery products.

Dough Ingredients

The flour utilized in the present invention is preferably a wheat flour, such as Hummer flour, available from Cargill, Inc., Minneapolis, Minn. The wheat flour preferably has about 14% protein (14% mb), about 0.54% ash (14% mb) and a Falling Number Value of about 260. Farinograph absorption is preferably about 63%, time to peak is about 6 minutes and the mixing tolerance index is about 30 BU. In preferred embodiments, a non-bromated flour is used.

Wheat gluten, preferably vital wheat gluten, may be added to the formula to maintain the gluten content of the dough. If wheat gluten is added, it is preferably added in an amount ranging from 0 wt-% to about 20 wt-%, more preferably in the range of about 5 wt-% to 15 wt-%. In one embodiment, vital wheat gluten is present at a level of about 6 wt-%. Lower protein wheat flour may also be used in the present invention with the addition of more vital wheat gluten.

The dough in accordance with the present invention may optionally include a fat component. The fat component serves to plasticize the dough, and to soften the texture of the final baked product. The fat component can also help to improve the specific volume of the final product. Very low fat products (i.e., less than about 3%) and very high fat products (e.g., greater than about 10%) generally have reduced specific volume. The fat component can be in either liquid or solid form. Fat can be present in bakery products at levels ranging from about 0 wt-% to about 20 wt-%. Preferably, the fat is present in products of the present invention at levels ranging from 0 wt-% to about 15 wt-%, more preferably between about 1 wt-% to about 10 wt-%. In one preferred embodiment, fat is present at a level of about 7.5 wt-%.

Examples of fats that may be suitable for use in the present invention, include, but are not limited to oils and shortenings made from soybeans, corn, canola, cottonseeds, olives, tropical plants, other plants, and animal fats, such as butter, tallow and lard. Fat substitutes may also be used.

Other conventional dough ingredients can be included, such as dough conditioners, emulsifiers, salt, flavorings, mold inhibitors and the like. If such ingredients are used, they are generally present in amounts sufficient to have the desired effect on the dough and final product properties, without adversely affecting the processability of the dough or the organoleptic properties of the final product. Preferably, these ingredients are present in amounts ranging from about 0 wt-% to about 5 wt-% of each ingredient, more preferably less than about 3 wt-% of each ingredient.

A common flavoring agent added to doughs is a sweetening agent. The sweetening agent imparts a desirable flavor and color to the baked product, and may be useful when the yeast is generating carbon dioxide. Both natural and artificial sweeteners may be used, including, but not limited to, sugar (sucrose), sucralose, aspartame, sugar alcohols, syrups, high fructose corn syrups, and the like.

Yeast is added to the dough ingredients at a level sufficient to provide the desired carbon dioxide level in the dough during proofing, and the desired taste and texture to the final baked product. Preferably, fresh bakers yeast is used. Generally, yeast is present in amounts ranging from 1 wt-% to about 10 wt-%, preferably from about 3 wt-% to about 5 wt-% of the dough formula.

Although the standard of identity for bread requires the use of yeast as the leavening agent, many other bakery products utilize chemical leavening agents, or a combination of yeast and chemical leavening agents. Products made in accordance with the present invention that utilize chemical leavening agents or combinations of leavening agents will typically include such leavening agents at levels sufficient to provide the desired level of carbon dioxide in the dough to result in the suitable final product characteristics.

Water is added to the dough ingredients in accordance with the present invention at levels ranging from about 20 wt-% to about 50 wt-%. Those skilled in the art will understand that the amount of water added to the dough ingredients is a complex variable, depending on the type and amount of ingredients used, the environmental conditions, the mixing conditions, and the like. The water content of the dough is preferably optimized based on dough handling properties and desired final product characteristics.

Bread and other bakery products made in accordance with the present invention preferably contain between about 5% and 40% protein and have a specific volume of at least about 3.5 cc/g. For those bread and bakery products containing soy protein in accordance with the present invention, preferably the soy protein content is between about 10% and 20%, with the bread product preferably having a specific volume of at least 3.5 cc/g.

With respect to fiber, bread and bakery products of the present invention contain between about 10% and 40% dietary fiber, and have a specific volume of at least 3.5 cc/g. In other embodiments of the present invention, bread and bakery products contain between about 10% and 40% dietary fiber, and between about 5% and about 40% protein, while having specific volume of 3.5 cc/g or greater.

The following examples demonstrate the use of extruded protein ingredients in bread and other bakery products. In the following examples, the protein ingredient is extruded, and the extrudate is dried as needed, then crushed to a fine particle size, similar to flour. Preferably, the average particle size of the extruded and ground protein ingredient is between about 20-400 microns, more preferably between about 20-100 microns. The extruded protein ingredient in dried, crushed form is then incorporated with the additional dough ingredients as described below.

The Dumas method is a known method for determining protein content of a sample. The principle of the Dumas method is to burn the sample at high temperature, converting all of the nitrogen in the sample to elemental nitrogen. The trapped nitrogen is subsequently measured by a thermal conductivity cell. The nitrogen determined is converted to protein content using a factor (“F”). Different proteins have different factors due to the differences in the amino acid complement of the different proteins. The F factor for soy protein is F=6.25 while for wheat gluten the F factor is F=5.70. To determine the soy protein content, therefore, the following formula is used: % nitrogen x 6.25=% soy protein by weight.

### Example 1

### Extruded Soy Flour

Table 2 shows bread made with minced textured soy flour (50% protein, 100% soy protein) from Cargill, Inc., MN. This formula produced bread with good specific volume relative to unextruded soy flour.

TABLE 2
Extruded Soy Flour 5P vs. Unextruded Soy Flour

| | Extruded Soy | | Unextruded | |
|---|---|---|---|---|
| | Flour 5P* | | Soy Flour | |
| Ingredient | Percent | Mass (g) | Percent | Mass (g) |
| Flour¹ | 43.278 | 259.67 | 46.073 | 276.44 |
| Lecithin² | 2.569 | 15.41 | 0 | 0 |
| Extruded Soy Flour 5P | 41.610 | 249.66 | 0 | 0 |
| Unextruded 15% | 0 | 0 | 45.665 | 273.99 |
| Relecithinated Soy Flour³ | | | | |
| Vital Wheat Gluten⁴ | 5.000 | 30.00 | 5.000 | 30.00 |
| Soybean Oil⁵ | 4.281 | 25.69 | 0 | 0 |
| ADA⁶ | 0.002 | 0.01 | 0.002 | 0.01 |
| Salt | 2.000 | 12.00 | 2.000 | 12.00 |
| CSL⁷ | 0.450 | 2.70 | 0.450 | 2.70 |
| DATEM⁸ | 0.350 | 2.10 | 0.350 | 2.10 |
| Sodium Stearoyl Lactylate⁹ | 0.450 | 2.70 | 0.450 | 2.70 |
| Ascorbic Acid¹⁰ | 0.010 | 10.06 | 0.010 | 0.06 |
| Total | 100.000 | 600.00 | 100.000 | 600.00 |
| Yeast | | 25.00 | | 25.00 |
| Water (60 F.) | | 535.00 | | 551.6 |
| Average Specific Volume | | 3.8 | | 2.6 |
| (cc/g) | | | | |

¹Cargill “Progressive Baker High Gluten Hummer” Flour, Cargill, Inc., MN
²Central Soya Centrol ® 3F-UB Lecithin, Central Soya, IN
³Cargill 200/70 + 15% Relecithinated Soy Flour, Cargill, Inc., MN
⁴ADM Ogilvie Provim ESP ® Vital Wheat Gluten, Archer Daniels Midland Company, IL
⁵Cargill Soybean Salad Oil (soybean oil with citric acid as preservative), Cargill, Inc., MN
⁵Puratos S-500 Red Dough Conditioner, Puratos, NJ
⁶Benchmate Brand ™ ADA-PAR azodicarbonamide, Burns Philp Food, Inc., MO
⁷ADM CSL calcium stearoyl lactylate, Archer Daniels Midland Company, IL
⁸Danisco ® Panodan ® 205K diacetyl tartaric acid esters of mono- and diglycerides (DATEM), Danisco Cultor, Inc., USA
⁹ADM Arkady Paniplex ® SK sodium stearoyl lactylate, Archer Daniels Midland Company, IL
¹⁰Benchmate Brand ™ PAC-C-120 ascorbic acid, Burns Philp Foods, Inc., MO

The ingredients were mixed in a Hobart N-50 mixer for 1 minute on the low setting, then 12 minutes on the medium setting and given 20 minutes rest. 220 grams of dough were made and rounded, then allowed to rest for 10 minutes. The dough was sheeted to 4 mm in thickness, rolled into a cylinder, placed in a pup loaf pan, and proofed for 60 minutes in a proof box at 115° F. and 95% relative humidity. The dough was baked 19 minutes at 400° F.

The soy protein content of the bread was calculated to be 13% by weight. This bread therefore meets the FDA's requirements for making a soy protein health claim.

### Example 2

### Extruded Soy Protein Concentrate

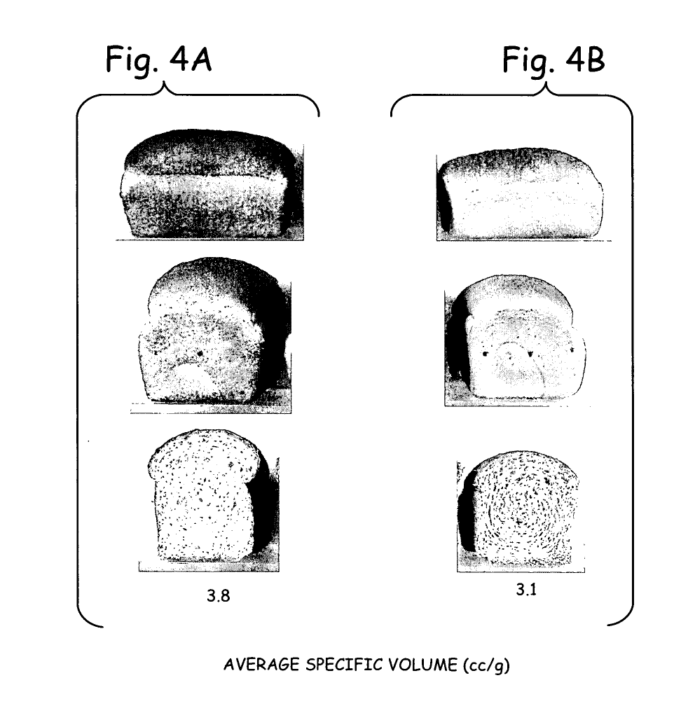

Extruded soy protein concentrate (Response 4310 from Central Soya, Ind.) and unextruded soy protein concentrate (Procon 2000 from Central Soya, Ind.) were obtained. The sample containing extruded and ground soy protein concentrate produced bread with higher specific volume than the sample containing unextruded soy protein concentrate. Table 3 lists the bread formulas and FIGS. 4A and 4B show the finished breads.

TABLE 3
Extruded Soy Protein Concentrate (SPC) vs. Unextruded SPC

| | Extruded | | Unextruded | |
|---|---|---|---|---|
| | SPC 4310 | | SPC | |
| Ingredient | Percent | Mass (g) | Percent | Mass (g) |
| Flour | 52.90 | 317.41 | 52.90 | 317.41 |
| Lecithin | 2.57 | 15.44 | 2.57 | 15.44 |
| Extruded SPC 4310 | 31.05 | 186.31 | 0 | 0 |
| Unextruded SPC Procon 2000 | 0 | 0 | 31.05 | 186.31 |
| Vital Wheat Gluten | 6.00 | 36.00 | 6.00 | 36.00 |
| Soybean Oil | 3.07 | 18.44 | 3.07 | 18.44 |
| Salt | 2.00 | 12.00 | 2.00 | 12.00 |
| Dough Conditioner | 1.70 | 10.20 | 1.70 | 10.20 |
| Sodium Stearoyl Lactylate | 0.45 | 2.70 | 0.45 | 2.70 |
| Aspartame¹ | 0.25 | 1.50 | 0.25 | 1.50 |
| Total | 100.00 | 600.00 | 100.00 | 600.00 |
| Yeast | | 25.00 | | 25.00 |
| Water (60 F.) | | 500.00 | | 580.00 |
| Average Specific Volume | | 3.8 | | 3.1 |
| (cc/g) | | | | |

¹NutraSweet ® Custom Encapsulated 20 ™, NutraSweet Company, IL

The ingredients were mixed in a Hobart N-50 mixer for 1 minute on the low setting, then 15 minutes on the medium setting and given 20 minutes rest. 220 grams of dough were made and rounded, then allowed to rest for 10 minutes. The dough was sheeted to 4 mm in thickness, rolled into a cylinder, placed in a pup loaf pan, and proofed to 1 inch above the pan in a proof box at 115° F. and 95% relative humidity. The dough was baked 19 minutes at 400° F.

The soy protein content of the bread was calculated to be 13.5%. This bread therefore meets the FDA's requirements for making a soy protein health claim.

### Example 3

### Extruded Vital Wheat Gluten

Extruded and ground vital wheat gluten was obtained from Cargill, Inc, MN and unextruded vital wheat gluten was obtained from Archer Daniel Midland Company, IL. Table 4 lists the dough formulas used in this example.

The ingredients were mixed in a Hobart N-50 mixer for 1 minute on the low setting, then 10 minutes on the medium setting and given 20 minutes rest. 220 grams of dough were made and rounded, then allowed to rest for 10 minutes. The dough was sheeted to 4 mm in thickness, rolled into a cylinder, placed in a pup loaf pan, and proofed to 1 inch above the pan in a proof box at 115° F. and 95% relative humidity. The dough was baked 19 minutes at 400° F.

TABLE 4
Extruded Vital Wheat Gluten (VWG) vs. Unextruded VWG*

| | Extruded | | Unextruded | |
|---|---|---|---|---|
| | VWG | | VWG | |
| Ingredient | Percent | Mass (g) | Percent | Mass (g) |
| Flour | 47.00 | 282.01 | 47.00 | 282.01 |
| Lecithin | 1.57 | 9.44 | 1.57 | 9.44 |
| Extruded VWG | 36.50 | 219.00 | 0 | 0 |
| Unextruded VWG | 6.00 | 36.00 | 42.50 | 255.00 |
| Soybean Oil | 4.07 | 24.44 | 4.07 | 24.44 |
| Salt | 2.00 | 12.00 | 2.00 | 12.00 |
| Dough Conditioner | 1.70 | 10.20 | 1.70 | 10.20 |
| Sodium Stearoyl Lactylate | 0.45 | 2.70 | 0.45 | 2.70 |
| CSL | 0.45 | 2.70 | 0.45 | 2.70 |
| Aspartame | 0.25 | 1.50 | 0.25 | 1.50 |
| Total | 100.00 | 600.00 | 100.00 | 600.00 |
| Yeast | | 35.00 | | 35.00 |
| Water (60 F.) | | 420.00 | | 500.00 |
| Average Specific Volume | | 4.0 | | 9.6 |
| (cc/g) | | | | |

The dough made with unextruded vital wheat gluten was very rubbery and difficult to sheet and round. The dough with extruded vital wheat gluten (VWG) behaved like normal dough. The specific volume of the bread with unextruded VWG was not acceptable (9.6 cc/g). The specific volume of the bread with extruded VWG was acceptable (4.0 cc/g). The unextruded VWG breadcrumb was too chewy to eat. The extruded VWG breadcrumb had an acceptable texture. Extrusion therefore made VWG more inert in the dough/bread matrix. The protein content of the extruded VWG was calculated to be 75% and the wheat gluten protein content of the bread was calculated to be 25% by weight.

### Example 4

### SPI Buns with 60% Protein Extruded SPI

Buns were made from the formula listed in Table 5.

TABLE 5
SPI Buns

| Ingredient | Percent | Mass (g) |
|---|---|---|
| Flour | 48.590 | 291.54 |
| Lecithin | 1.574 | 9.44 |
| Extruded SPI | 36.500 | 219.00 |
| Vital Wheat Gluten | 6.000 | 36.00 |
| Soybean Oil | 4.074 | 24.44 |
| ADA | 0.002 | 0.01 |
| Salt | 2.000 | 12.00 |
| CSL | 0.450 | 2.70 |
| DATEM | 0.350 | 2.10 |
| Sodium Stearoyl Lactylate | 0.450 | 2.70 |
| Ascorbic Acid | 0.010 | 0.06 |
| Total | 100.000 | 600.00 |
| Yeast | | 35.00 |
| Water | | 490.00 |

The ingredients were mixed in a Hobart N-50 mixer for 1 minute on the low setting, then 20 minutes on the medium setting and given 20 minutes rest. 65 grams of dough were made and rounded. The dough was proofed for 60 minutes in a proof box at 115° F. and 95% relative humidity. The dough was baked 15 minutes at 400° F.

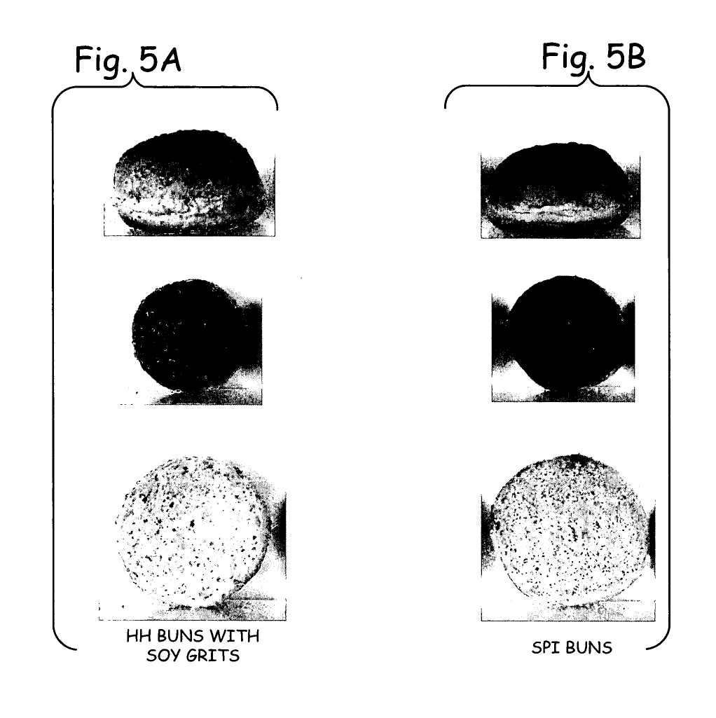

The soy protein content of the extruded and ground SPI buns was calculated to be 13.5% by weight. The specific volume of the SPI buns was found to be an acceptable level (4.3 cc/g) and similar to soy buns with large soy grits. FIGS. 5A and 5B show the extruded and ground SPI buns compared to soy protein buns with large soy grits. Both buns meet the FDA's requirements for making a soy protein health claim. The extruded and ground soy protein is relatively inert compared to the untreated soy protein (the soy grits) and therefore can be incorporated into bakery products as a smaller particulate; the extruded soy protein particulate is undetected in the final bakery product (the SPI buns in this case), which is desirable in certain bakery products. As will be appreciated by those of skill in the art, further optimization of ingredients (dextrose, vital wheat gluten, water, dough conditioners) may improve the specific volume of buns and similar products containing extruded and ground SPI.

Extruded Protein Mixes

Extruded protein mixes were also studied for use in making the high protein bread in accordance with the present invention. The extruded mixes were as follows:

Mix 1. 60% whey protein isolate (WPI) & 40% rice flour,

Mix 2. 70% SPI acidified to the isoelectric point & 30% rice flour,

Mix 3. 70% SPI fines & 30% rice flour,

Mix 4. 100% SPI,

Mix 5. 70% SPI & 30% wheat bran.

Nutritional analyses were run on the extruded product to determine the protein content and the results are given in Table 10. Calculations were also run on the bread based on the ingredient specifications and the results are also given in Table 10.

### Example 5

### Mix 1 and Extruded SPI

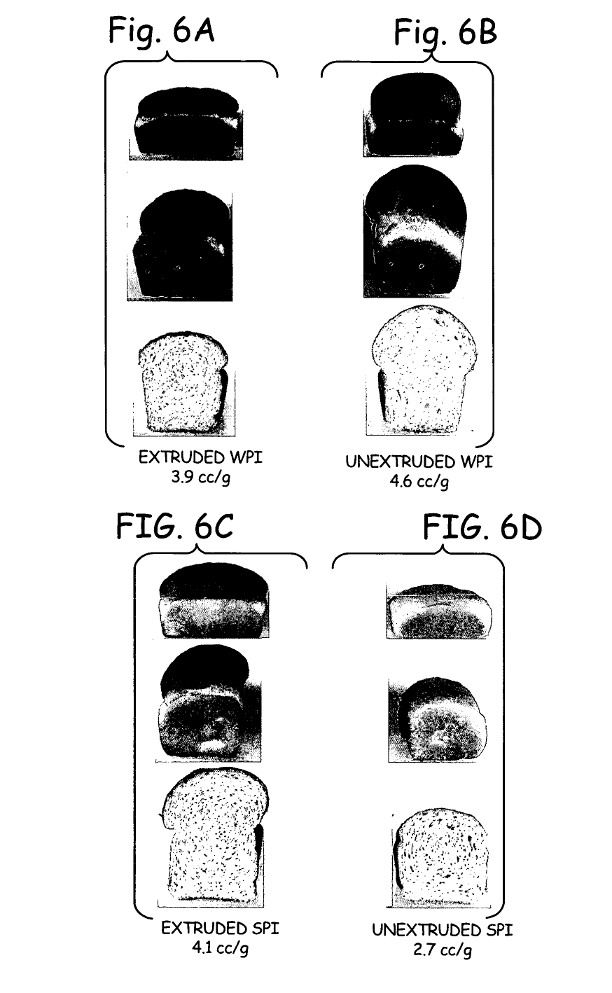

Mix 1 was made using the formula given above. Dough formulas are listed in Table 6 and finished breads are shown in FIGS. 6A-D.

TABLE 6
Extruded WPI vs. Unextruded WPI and Extruded SPI and Rice Flour vs.
Unextruded SPI and Rice Flour

| | Extruded WPI | | Unextruded | | | | | |
|---|---|---|---|---|---|---|---|---|
| | (Mix 1) | | WPI | | Extruded SPI | | Unextruded SPI | |
| | | Mass | | Mass | | Mass | | Mass |
| Ingredient | Percent | (g) | Percent | (g) | Percent | (g) | Percent | (g) |
| Flour | 47.02 | 282.01 | 47.02 | 282.01 | 47.02 | 282.01 | 47.02 | 282.01 |
| Lecithin | 1.57 | 9.44 | 1.57 | 9.44 | 1.57 | 9.44 | 1.57 | 9.44 |
| Extruded | 36.50 | 219.00 | 0 | 0 | 0 | 0 | 0 | 0 |
| WPI | | | | | | | | |
| (Mix 1) | | | | | | | | |
| Unextruded | 0 | 0 | 23.72 | 142.35 | 0 | 0 | 0 | 0 |
| WPI¹ | | | | | | | | |
| Rice Flour² | 0 | 0 | 12.78 | 76.65 | 0 | 0 | 12.78 | 76.65 |
| Extruded | 0 | 0 | 0 | 0 | 36.50 | 219.00 | 0 | 0 |
| SPI | | | | | | | | |
| Unextruded | 0 | 0 | 0 | 0 | 0 | 0 | 23.72 | 142.35 |
| SPI³ | | | | | | | | |
| Vital | 6.00 | 36.00 | 6.00 | 36.00 | 6.00 | 36.00 | 6.00 | 36.00 |
| Wheat | | | | | | | | |
| Gluten | | | | | | | | |
| Soybean | 4.07 | 24.44 | 4.07 | 24.44 | 4.07 | 24.44 | 4.07 | 24.44 |
| Oil | | | | | | | | |
| Salt | 2.00 | 12.00 | 2.00 | 12.00 | 2.00 | 12.00 | 2.00 | 12.00 |
| CSL | 0.45 | 2.70 | 0.45 | 2.70 | 0.45 | 2.70 | 0.45 | 2.70 |
| Dough | 1.70 | 10.20 | 1.70 | 10.20 | 1.70 | 10.20 | 1.70 | 10.20 |
| Conditioner | | | | | | | | |
| Sodium | 0.45 | 2.70 | 0.45 | 2.70 | 0.45 | 2.70 | 0.45 | 2.70 |
| Stearoyl | | | | | | | | |
| Lactylate | | | | | | | | |
| Aspartame | 0.25 | 1.50 | 0.25 | 1.50 | 0.25 | 1.50 | 0.25 | 1.50 |
| Total | 100.00 | 600.00 | 100.00 | 600.00 | 100.00 | 600.00 | 100.00 | 600.00 |
| Yeast | | 35.00 | | 35.00 | | 35.00 | | 35.00 |
| Water | | 490.00 | | 299.50 | | 490.00 | | 627.70 |
| (60 F.) | | | | | | | | |
| Average | | 3.9 | | 4.6 | | 4.1 | | 2.7 |
| Specific | | | | | | | | |
| Volume | | | | | | | | |
| (cc/g) | | | | | | | | |

¹BiPro whey protein isolate, Davisco, Inc., MN
²Bob's Red Mill Stone Ground White Rice Flour, Bob's Red Mill Natural Foods, OR
³Prolisse 500 soy protein isolate, Cargill, Inc., MN

For bread containing WPI, the ingredients were mixed in a Hobart N-50 mixer for 1 minute on the low setting, then 15 minutes on the medium setting and given 20 minutes rest. 220 grams of dough were made and rounded, then allowed to rest for 10 minutes. The dough was sheeted to 4 mm in thickness, rolled into a cylinder, placed in a pup loaf pan, and proofed for 60 minutes in a proof box at 115° F. and 95% relative humidity. The dough was baked 19 minutes at 400° F.

For bread containing SPI, the ingredients were mixed in a Hobart N-50 mixer for 1 minute on the low setting, then 20 minutes on the medium setting and given 20 minutes rest. 220 grams of dough were made and rounded, then allowed to rest for 10 minutes. The dough was sheeted to 4 mm in thickness, rolled into a cylinder, placed in a pup loaf pan, and proofed for 60 minutes in a proof box at 115° F. and 95% relative humidity. The dough was baked 19 minutes at 400° F.

The extruded Mix 1 dough proofed to height and had a small amount of oven spring; the unextruded WPI dough did not proof to height and exhibited a surprising amount of oven spring. A ground 60% protein (95% of the total protein from soy protein) extruded SPI produced bread that had higher specific volume than the unextruded sample. The 60% protein extruded SPI (4130 Crisps from Cargill, Inc., MN) was a mixture of SPI and rice flour. The unextruded WPI breadcrumb was too hard to eat. The extruded WPI breadcrumb had an acceptable texture. Extrusion therefore made both WPI and SPI relatively more inert in the dough/bread matrix than unextruded WPI and SPI. The protein content of Mix 1 was tested to be 57.4 by Dumas (F=6.25) and the 10 whey protein content of the bread was calculated to be 13% by weight. The protein content of the extruded SPI Crisps was tested to be 63.5 by Dumas (F=6.25) and the soy protein content of the bread was calculated to be 12.9% by weight.

### Example 6

### Mixes 2 and 3

Bread made with extruded and ground Mix 2 and Mix 3 had improved average specific volume compared to the unextruded samples. As one skilled in the art may appreciate, further optimization of ingredients (water, dextrose, vital wheat gluten, dough conditioners) may lead to more dramatic results. Table 7 lists the Mix 2 and Mix 3 bread formulas and the average specific volume results.

TABLE 7
Extruded Mix 2 & Mix 3 vs. Unextruded Acidified SPI and SPI Fines

| | Extruded | | Unextruded | | Extruded SPI | | Unextruded | |
|---|---|---|---|---|---|---|---|---|
| | Acidified SPI | | Acidified SPI | | Fines | | SPI Fines | |
| | | Mass | | Mass | | Mass | | Mass |
| Ingredient | Percent | (g) | Percent | (g) | Percent | (g) | Percent | (g) |
| Flour | 47.77 | 286.61 | 47.77 | 286.61 | 47.14 | 282.81 | 47.14 | 282.81 |
| Lecithin | 1.57 | 9.44 | 1.57 | 9.44 | 1.57 | 9.44 | 1.57 | 9.44 |
| Extruded | 35.73 | 214.40 | 0 | 0 | 0 | 0 | 0 | 0 |
| SPI (Mix 2) | | | | | | | | |
| Unextruded | 0 | 0 | 25.01 | 150.08 | 0 | 0 | 25.46 | 152.74 |
| SPI | | | | | | | | |
| Rice Flour | 0 | 0 | 10.72 | 64.32 | 0 | 0 | 10.91 | 65.46 |
| Extruded | 0 | 0 | 0 | 0 | 36.37 | 218.20 | 0 | 0 |
| SPI (Mix 3) | | | | | | | | |
| Vital | 6.00 | 36.00 | 6.00 | 36.00 | 6.00 | 36.00 | 6.00 | 36.00 |
| Wheat | | | | | | | | |
| Gluten | | | | | | | | |
| Soybean | 4.07 | 24.44 | 4.07 | 24.44 | 4.07 | 24.44 | 4.07 | 24.44 |
| Oil | | | | | | | | |
| Salt | 2.00 | 12.00 | 2.00 | 12.00 | 2.00 | 12.00 | 2.00 | 12.00 |
| CSL | 0.45 | 2.70 | 0.45 | 2.70 | 0.45 | 2.70 | 0.45 | 2.70 |
| Dough | 1.70 | 10.20 | 1.70 | 10.20 | 1.70 | 10.20 | 1.70 | 10.20 |
| Conditioner | | | | | | | | |
| Sodium | 0.45 | 2.70 | 0.45 | 2.70 | 0.45 | 2.70 | 0.45 | 2.70 |
| Stearoyl | | | | | | | | |
| Lactylate | | | | | | | | |
| Aspartame | 0.25 | 1.50 | 0.25 | 1.50 | 0.25 | 1.50 | 0.25 | 1.50 |
| Total | 100.00 | 600.00 | 100.00 | 600.00 | 100.00 | 600.00 | 100.00 | 600.00 |
| Yeast | | 35.00 | | 35.00 | | 35.00 | | 35.00 |
| Water | | 490.00 | | 586.60 | | 507.80 | | 548.60 |
| (60 F.) | | | | | | | | |
| Average | | 3.5 | | 2.6 | | 3.0 | | 2.36 |
| Specific | | | | | | | | |
| Volume | | | | | | | | |
| (cc/g) | | | | | | | | |

The ingredients were mixed in a Hobart N-50 mixer for 1 minute on the low setting, then 10 minutes on the medium setting and given 20 minutes rest. 220 grams of dough were made and rounded, then allowed to rest for 10 minutes. The dough was sheeted to 4 mm in thickness, rolled into a cylinder, placed in a pup loaf pan, and proofed for 60 minutes in a proof box at 115° F. and 95% relative humidity. The dough was baked 19 minutes at 400° F.

The protein content for Mix 2 was tested to be 62.8 (F=6.25) by Dumas and the soy protein content of the bread was calculated to be 13.2% by weight. The protein content for Mix 3 was tested to be 63.1 (F=6.25) by Dumas and the soy protein content of the bread was calculated to be 12.7% by weight.

### Example 7

### Extruded Mix 4

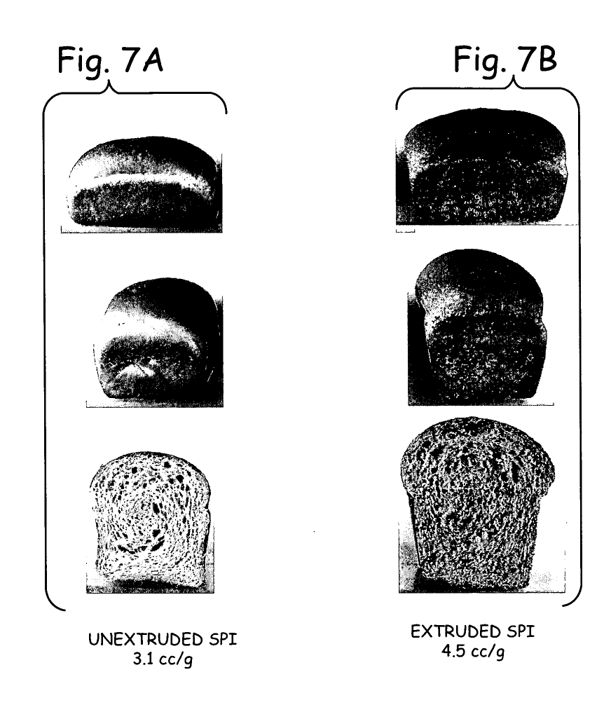

Samples were made using the formula for Mix 4. Extruded and ground SPI made acceptable bread whereas unextruded SPI did not make good bread. Table 8 lists the Mix 4 bread formulas and FIGS. 7A and 7B show the baked breads.

TABLE 8
Extruded SPI (Mix 4) vs. Unextruded SPI

| | |
|---|---|
| Extruded | Unextruded |
| SPI (Mix 4) | SPI |

| Ingredient | Percent | Mass (g) | Percent | Mass (g) |
|---|---|---|---|---|
| Flour | 53.71 | 322.25 | 53.71 | 322.25 |
| Lecithin | 1.57 | 9.44 | 1.57 | 9.44 |
| Extruded SPI | 25.79 | 154.76 | 0 | 0 |
| (Mix 4) | | | | |
| Unextruded | 0 | 0 | 25.79 | 154.76 |
| SPI | | | | |
| Dextrose | 2.00 | 12.00 | 2.00 | 12.00 |
| Vital Wheat | 8.00 | 48.00 | 8.00 | 48.00 |
| Gluten | | | | |
| Soybean Oil | 4.07 | 24.44 | 4.07 | 24.44 |
| Salt | 2.00 | 12.00 | 2.00 | 12.00 |
| CSL | 0.45 | 2.70 | 0.45 | 2.70 |
| Dough | 1.70 | 10.20 | 1.70 | 10.20 |
| Conditioner | | | | |
| Sodium | 0.45 | 2.70 | 0.45 | 2.70 |
| Stearoyl | | | | |
| Lactylate | | | | |
| Aspartame | 0.25 | 1.50 | 0.25 | 1.50 |
| Total | 100.00 | 600.00 | 100.00 | 600.00 |
| Yeast | | 35.00 | | 35.00 |
| Water (60 F.) | | 515.00 | | 620.00 |
| Average | | 4.5 | | 3.1 |
| Specific | | | | |
| Volume (cc/g) | | | | |

The ingredients were mixed in a Hobart N-50 mixer for 1 minute on the low setting, then 15 minutes on the medium setting and given 20 minutes rest. 220 grams of dough were made and rounded, then allowed to rest for 10 minutes. The dough was sheeted to 4 mm in thickness, rolled into a cylinder, placed in a pup loaf pan, and proofed to 1 inch above the pan in a proof box at 115° F. and 95% relative humidity. The dough was baked 19 minutes at 400° F.

The protein content of Mix 4 was tested to be 81.2 (F=6.25) by Dumas and the soy protein content of the bread was calculated to be 12.9% by weight.

The following examples are embodiments of the present invention in which a protein source is coextruded with a fiber source to provide a high protein, high fiber product. In accordance with the present invention, the coextruded protein and fiber ingredient provides improved specific volumes and bread textures, while also providing protein and fiber levels sufficient to meet FDA guidelines for these nutrients.

### Example 8

### Extruded Mix 5

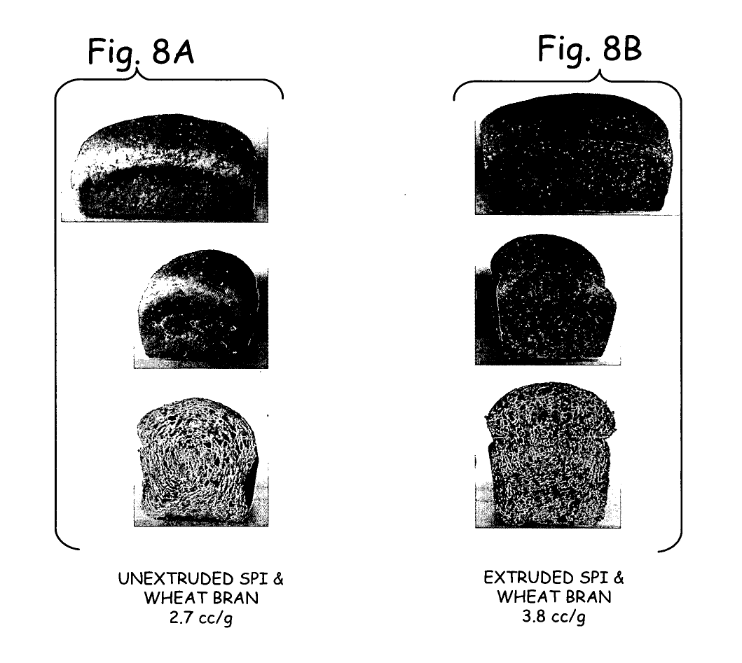

Samples were made using the formula for Mix 5. Table 9 lists the Mix 5 bread formulas and FIGS. 8A and 8B show the baked breads. Bread containing extruded and ground Mix 5 had an acceptable specific volume, while bread containing unextruded SPI and wheat bran did not.

TABLE 9
Extruded SPI and Wheat Bran (Mix 5) vs. Unextruded SPI and Wheat
Bran

| | Extruded SPI | | Unextruded | |
|---|---|---|---|---|
| | & Wheat | | SPI and | |
| | Bran (Mix 5) | | Wheat Bran | |
| Ingredient | Percent | Mass (g) | Percent | Mass (g) |
| Flour | 43.82 | 262.95 | 43.82 | 262.95 |
| Lecithin | 1.57 | 9.44 | 1.57 | 9.44 |
| Extruded SPI (Mix 5) | 35.68 | 214.06 | 0 | 0 |
| Unextruded SPI | 0 | 0 | 24.97 | 149.84 |
| Wheat Bran¹ | 0 | 0 | 10.70 | 64.22 |
| Dextrose | 2.00 | 12.00 | 2.00 | 12.00 |
| Vital Wheat Gluten | 8.00 | 48.00 | 8.00 | 48.00 |
| Soybean Oil | 4.07 | 24.44 | 4.07 | 24.44 |
| Salt | 2.00 | 12.00 | 2.00 | 12.00 |
| CSL | 0.45 | 2.70 | 0.45 | 2.70 |
| Dough Conditioner | 1.70 | 10.20 | 1.70 | 10.20 |
| Sodium Stearoyl Lactylate | 0.45 | 2.70 | 0.45 | 2.70 |
| Aspartame | 0.25 | 1.50 | 0.25 | 1.50 |
| Total | 100.00 | 600.00 | 100.00 | 600.00 |
| Yeast | | 35.00 | | 35.00 |
| Water (60 F.) | | 612.60 | | 640.00 |
| Average Specific Volume | | 3.8 | | 2.7 |
| (cc/g) | | | | |

¹Bob's Red Mill Wheat Bran, Bob's Red Mill Natural Foods, OR

The ingredients were mixed in a Hobart N-50 mixer for 1 minute on the low setting, then 15 minutes on the medium setting and given 20 minutes rest. 220 grams of dough were made and rounded, then allowed to rest for 10 minutes. The dough was sheeted to 4 mm in thickness, rolled into a cylinder, placed in a pup loaf pan, and proofed to 1 inch above the pan in a proof box at 115° F. and 95% relative humidity. The dough was baked 19 minutes at 400° F.

The protein content of Mix 5 was tested to be 67.6 (F=6.25) by Dumas and the soy protein content of the bread was calculated to be 13.6% by weight. Table 10 shows the tested and calculated protein content for Mixes 1-5.

TABLE 10
Tested vs. Calculated Protein Content for Mixes 1-5

| | Protein by Dumas | Protein by Calculation |
|---|---|---|
| | for dry mix | for baked product |
| Mix | (F = 6.25) | (weight %) |
| 1 | 57.4 | 13.0 |
| 2 | 62.8 | 13.2 |
| 3 | 63.1 | 12.7 |
| 4 | 81.2 | 12.9 |
| 5 | 67.6 | 13.6 |

### Example 9

### Extruded and Ground SPI and Soy Fiber vs. Unextruded SPI and Soy Fiber

A high protein, high fiber product was made according to the formula in Table 11. The extruded SPI and soy fiber ingredient of Table 11 was prepared by extruding a mixture comprising 30 wt-% SPI and 70 wt-% soy fiber, and then grinding the material to a fine powder.

TABLE 11
Extruded and Ground SPI and Soy Fiber

| | Extruded SPI | | Unextruded | |
|---|---|---|---|---|
| | and Soy | | SPI and Soy | |
| | Fiber Product | | Fiber Product | |
| Ingredient | Percent | Mass (g) | Percent | Mass (g) |
| Hummer Flour | 47.12 | 282.01 | 47.12 | 282.01 |
| Lecithin | 1.58 | 9.44 | 1.58 | 9.44 |
| Soy Fiber and SPI | 0.00 | 0.00 | 36.59 | 219.00 |
| Extruded Soy Fiber and | 36.59 | 219.00 | 0.00 | 0.00 |
| SPI | | | | |
| Vital Wheat Gluten | 6.02 | 36.00 | 6.02 | 36.00 |
| Soybean Oil | 4.08 | 24.44 | 4.08 | 24.44 |
| Salt | 2.01 | 12.00 | 2.01 | 12.00 |
| S-500 | 1.70 | 10.20 | 1.70 | 10.20 |
| Sodium Stearoyl Lactylate | 0.45 | 2.70 | 0.45 | 2.70 |
| Calcium Stearoyl Lactylate | 0.45 | 2.70 | 0.45 | 2.70 |
| Total | 100.00 | 598.49 | 100.00 | 598.49 |
| Water | | 397.1 | | 762.2 |
| Yeast | | 34.00 | | 35.00 |

| | | |
|---|---|---|
| Average Specific Volume | 3.96 | 2.3 |
| (cc/g) | | |

The ingredients were mixed in a Hobart N-50 mixer for 1 minute on the low speed, then for 10 minutes on the medium setting. The dough was allowed to rest for 10 minutes, then was divided into 220 g rounds and allowed to rest for another 10 minutes. The dough was then sheeted to a thickness of 4 mm, rolled into a cylinder, and placed into a pup loaf pan. The dough was proofed to a height of 1 inch above the edge of the pan in a proof box at 115° F. and 95% relative humidity. The dough was baked 19 minutes at 400° F.

The dough made with the control formula required the addition of more water than the extruded formula in order for the dough to form and be workable, due to the high protein and fiber levels.

The specific volume for the high protein, high fiber bread product made with the extruded protein and fiber ingredient of the present invention was almost 4 cc/g, whereas the control product, made with the same level of protein and fiber in an unextruded form, had a specific volume of 2.3.

Low Moisture Nutritional Products

Nutritional products, such as nutritional bars, have grown in popularity as a quick, easy to use source of nutrition for adults and children. There are a wide variety of nutritional bars, such as breakfast bars, protein bars, energy bars, diet bars, snack bars, and the like, which strive to deliver a high level of nutrition in a single serving, ready-to-eat form. However, the level of nutritive ingredients, such as protein, that can be added to these nutritive bars is significantly limited by the premature firming these ingredients cause in the products. The premature firming of nutritional bars during their shelf life severely limits the duration of consumer acceptability of these products, requiring food manufacturers to either limit the amount of nutritive ingredients in the bars, or to dispose of large quantities of unacceptably firmed products before the end of their shelf life.

A number of other low moisture foods or food materials may be candidates for protein or fiber fortification. Such fortification can have a negative effect on the ability to manufacture the food or its consumer appeal after manufacture. Examples may include, without limitation: pasta, crackers, extruded chips, cereals and pretzels. Use of ingredients made according to this invention may permit substantial fortification without significant loss of desired processing or sensory acceptability.

Many nutritional food products are formulated to promote weight loss or weight maintenance. Common strategies include fat reduction through replacement of fats with fat mimetics, calorie reduction through replacement of caloric carbohydrates with non-caloric carbohydrates, and carbohydrate deprivation by replacement of caloric carbohydrates with polyols, proteins and non-caloric carbohydrates. The latter strategy has been popularized in such branded diets as the Atkin's and South Beach diets, but can be generalized as “low carb” diets where practitioners attempt to eliminate all digestible carbohydrates from their diets. Manufacturers of products intended for this use must find ways to replace the functionality of starches and sugars in foods. More exactly, they must replace the bulk of these products with non-carbohydrate components that do not lead to unacceptable product palatability and stability. Nutrition bars are one common product intended to serve the weight loss market and numerous products are marketed to followers of low carbohydrate diets. Powdered fibers and proteins are often times poor substitutes for digestible carbohydrates as will be shown in examples below.

This invention enables formulators greater latitude in formulation since the extruded and ground products comprised of protein and fiber can be incorporated with a smaller impact on bar firming. Bar firming is generally a greater problem in low carbohydrate nutrition bars. The physical attributes of these extruded and ground products may allow for higher levels of protein or fiber inclusion, and reduction in plasticizing sugars or polyols. This can be a benefit in further lowering the carbohydrate content of the finished foods. It can also be a benefit in lowering the polyol content of foods, as some consumers have negative reactions to high doses.

Within this concept it must be recognized that different fiber and protein components, even after extrusion and grinding will have different functional and “health” properties. Consequently, different compositions can be developed to achieve unique functional and health goals within the concept of “low carbohydrate” extruded and ground ingredients. For example, some compositions could be relatively high in soluble fiber to provide cardiovascular benefits in combination with low carbohydrate bulk while other compositions could be high in insoluble fiber to provide gut health benefits in combination with low carbohydrate bulk. The combinations of compositions within the category of low carbohydrate extruded and ground ingredients may include specific fibers known to be especially effective in delivering a health benefit in combination with fibers that provide general benefits whose combination results in cost-effective delivery for the food product.

Nutritional bar manufacture is typically a multistage process. Liquid ingredients (syrups, liquid polyols, water, oils, etc.) are blended together. Dry powdered ingredients are then mixed with the liquid components. During this stage, it is important that the combination of liquid and dry ingredients mixes well to achieve the desired degree of homogeneity. Ingredients that interact too extensively with the syrup may produce a dry crumbly dough that cannot be effectively mixed. While different methods can be used to evaluate the firmness of a dough at this point, they can all be generalized to say that these mixes are fluid and soft and can be compared to a cake batter or peanut butter. Some bars are further supplemented by adding fruit, nuts or large (2-3 mm) extruded crisps at this point.

Typically, the dough at this point is too soft to form, so the dough is allowed to cure for 2-72 hours. During this period, the dough firms considerably and reaches a firmness at which the dough is self-supporting. A cut piece of dough will sag or flow very slowly, if at all. The dough at this point would be more similar to stiff cookie dough. The dough at this stage may be cut into the portion size desired, coated with a chocolate or other coating and packaged.

After manufacture, the bar may continue to firm before being eaten by the consumer. While the firmness may be initially acceptable, in many cases the bar will become unacceptably firm before the 1-year safety shelf life is achieved. This leads to either expensive discarding of unusable product or unsatisfied consumers and lost market opportunity.

The problems associated with excessive firmness are accentuated as the proportion of protein or fiber is increased in the bar formulation. Manufacturers may wish to produce nutrition bars intended for very high protein consumers like body builders or for people restricting their carbohydrate intake like diabetics or those following a minimal carbohydrate diet. Some manufacturers wish to increase the fiber content to provide better satiation, reduction of calorie density, or other health benefits associated with fiber consumption. High concentrations of protein and fiber can make the initial bar dough too firm for processing, and even if the dough is processable, the resulting bars may be too firm to consume. Examples provided herein will demonstrate the nature of this problem and the use of this invention in providing an acceptable high protein or fiber bar.

In embodiments of the present invention, the acceptable firmness window for bar products (as measured in Example 10) at up to about 12 months of shelf life is between about 20 N (Newtons) to about 50N, preferably between about 20N to about 40N, and more preferably between about 25N to 30N.

Nutritional bars typically comprise a protein source, a plasticizer, and a sweetening agent. These bars usually have a moisture level of about 10-15% by weight. The protein source can be derived from any plant, animal or dairy source, and is present in the bars at a level of between about 15-50% by weight. For high protein bars, it is preferred to provide as much protein per bar as possible, and preferably bars made in accordance with the present invention contain between about 30-50% by weight protein, more preferably about 40% by weight protein.

Plasticizing agents useful for nutritional bars can include any conventional food-acceptable plasticizing agent including polyols such as glycerol or maltitol, or oils such as corn oil, coconut oil, vegetable oil, canola oil, tropical oil, and mixtures thereof. Sweetening agents can include natural and artificial sweetening agents, such as sucrose syrup, fruit purees, high fructose corn syrup, maltose syrup, dextrose syrup, and mixtures thereof. It will be apparent to those of skill in the art that many sweetening agents also have a plasticizing effect. The plasticizing and sweetening agents are typically present in bars at combined levels ranging from about 25% to about 70% by weight.

It has been unexpectedly discovered that by using the altered protein or fiber ingredient of the present invention, the premature firming of nutritional bars can be drastically reduced. Due to this reduction in firming, the acceptable shelf life of bars made in accordance with the present invention can be greatly extended as compared to the shelf life of a conventional bar. In another embodiment, the reduction in firming allows the inclusion of very high levels of protein or fiber, or both in a nutritional bar, substantially without an increase in the rate of firming as compared to a conventional high protein or high fiber nutritional bar.

In the examples shown below, an extruded protein in accordance with the present invention was used to replace some or all of the protein ingredient in bar formulations. In these embodiments, the extruded protein is preferably ground to an average particle size of less than about 100 microns, preferably between about 20-70 microns, and more preferably between about 50-60 microns.

### Example 10

### Model Bar System I

A model bar system comprising 30% protein, 15% plasticizer, and 55% sweetener was used to evaluate the firmness profile of bars containing various levels of extruded and ground soy protein isolate. Glycerol was used as the plasticizing agent, and corn syrup was used as the sweetener.

The firmness of the bars was measured with a TA.XT Texture Analyzer, available from Texture Technologies, Inc. (Scarsdale, N.Y.). A 1 cm hemispheric stainless steel probe was used to penetrate each bar at a 10 mm penetration point, at a rate of 1.0 mm/second. The bars were stored and the measurements taken at about 25° C. and at a relative humidity of about 25%.

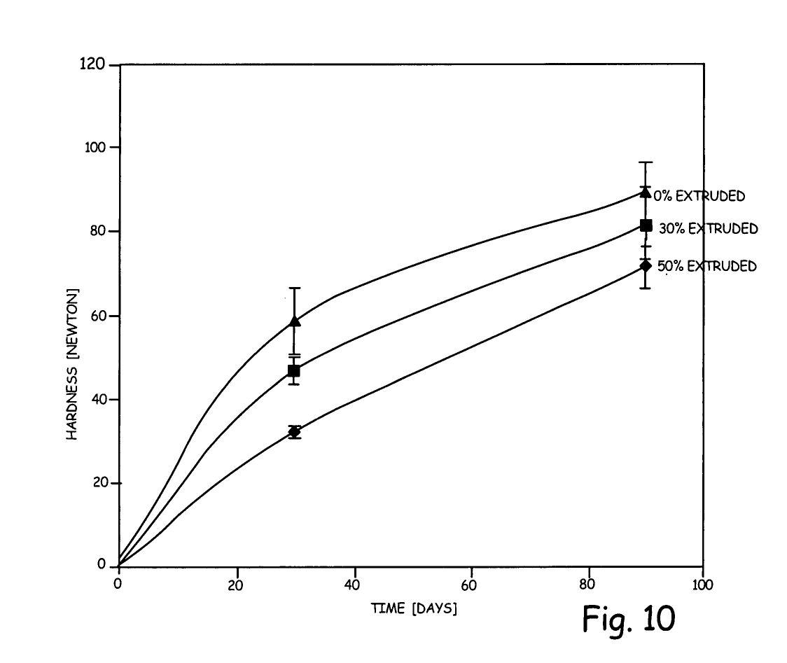

FIG. 10 shows the firmness profile of bars in which the protein ingredient comprises 0% extruded protein, 30% extruded protein, and 50% extruded protein, all percentages given by weight. As can be seen, as the level of extruded protein in the bar increases, the bar remains softer for a longer period of time, or is softer at a given point in time as compared to the bar containing unextruded protein.

### Example 11

### Chocolate and Caramel Coated Bar

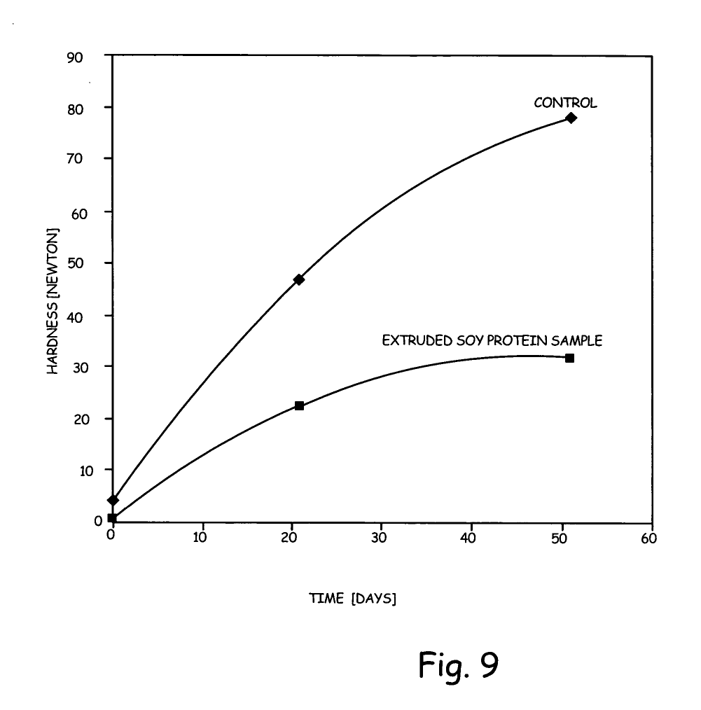

Table 12 shows the formulas of a chocolate and caramel coated bar made with extruded and unextruded soy protein isolate. FIG. 9 shows the firmness profile of the protein-containing center of the bar (without the coating) over a period of two months. Firmness was measured in the same manner as described for the preceding Example.

TABLE 12
Bar Formulations With and Without Extruded SPI

| Ingredient | Weight % | Mass (g) |
|---|---|---|
| Chocolate | 22 | 11.00 |
| Caramel | 30 | 15.00 |
| High Fructose Corn Syrup¹ | 22.8 | 11.40 |
| Vanilla flavor | 0.80 | 0.40 |
| Glycerin² | 6.40 | 3.20 |
| Canola oil | 1.60 | 0.80 |
| Water | 1.60 | 0.80 |
| Unextruded soy protein isolate or 1:1 | 14.8 | 7.4 |
| Blend of unextruded and extruded soy | | |
| protein isolate | | |

¹Cargill Isoclear ™ 42, Cargill, Inc., Minneapolis.
²Golden Select #2001

The dough for the bar was prepared by adding liquids to the mixing bowl and mixing them in a KitchenAid® Flour Power 9 cup mixer at a low speed for 15 seconds, scraping the sides of the bowl, and mixing again at a low speed for 15 seconds. The dry ingredients were then added to the bowl, and the combination was mixed at a low speed for 45 seconds, then the sides of the bowl were scraped, and the mixture mixed for another 15 seconds at a low speed.

Bars were shaped from the dough and the chocolate and caramel coating was applied. The bars were stored at 25° C. and 25% relative humidity. To take the texture measurements, the coating was scraped off to expose the dough, and the probe inserted directly into the protein-containing dough, which had a protein content of about 30% by weight (due to the removal of the chocolate and caramel coating). The results are shown in FIG. 10. As seen in the figure, bars made with the extruded protein ingredient of the present invention demonstrate a significant decreasing in firmness overall, and show a plateau in firmness earlier than the control. The bars made with unextruded protein showed unacceptable firming by 20 days, while the bars made with extruded protein remained in the acceptable 20-30N firmness range even at 55 days.

### Example 12

### High Protein Nutritional Bars

To demonstrate the ability to increase the amount of protein in a product containing the protein ingredient of the present invention substantially without adverse effects as compared to a typical high protein product, a control product was made according the formula in Table 12 above, and a high protein product was made containing 40% by weight protein (without the chocolate and caramel coating) comprising a 1:1 blend of the extruded soy protein isolate and unextruded soy protein isolate in accordance with the present invention.

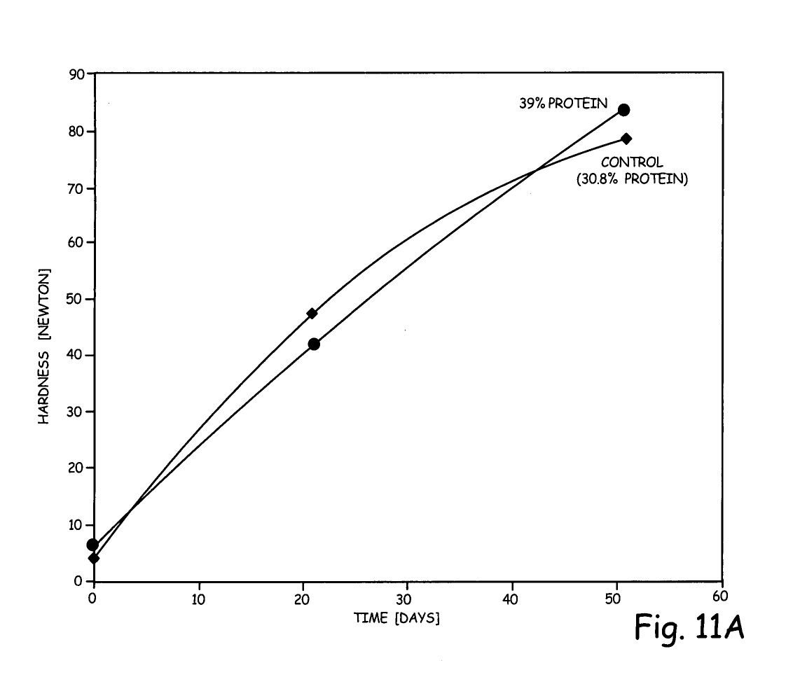

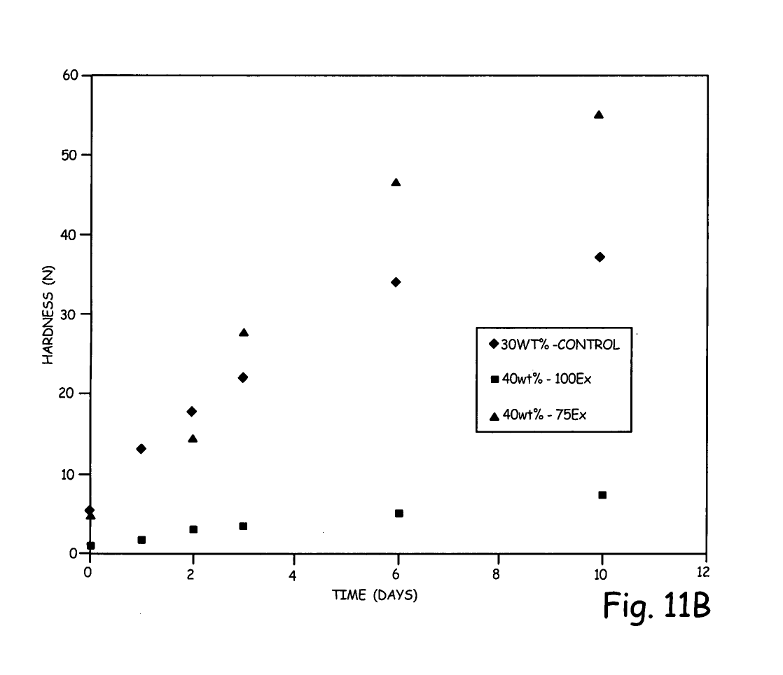

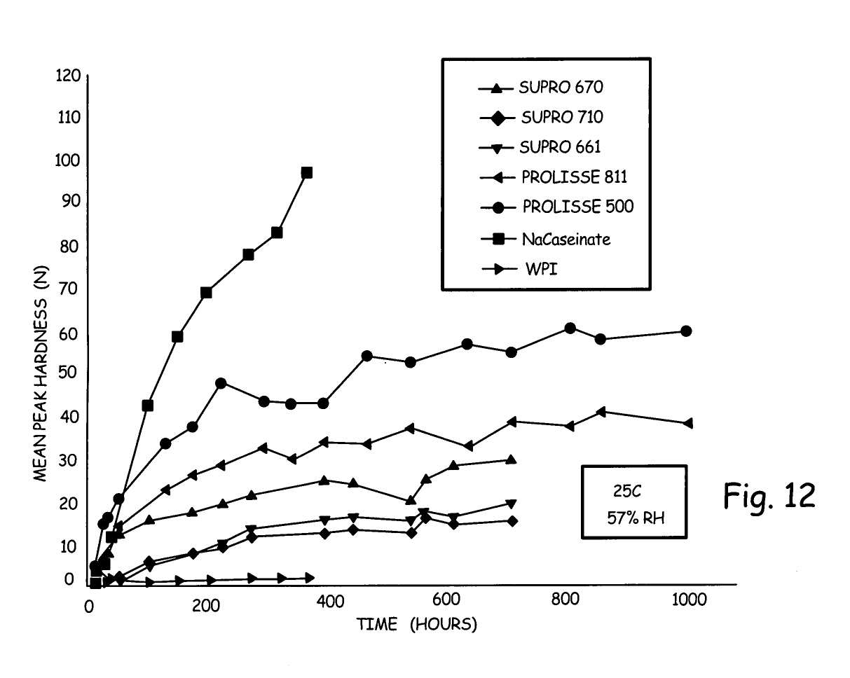

The firmness was measured as described above, and the results are shown in FIG. 11A. As can be seen, by using the protein ingredient of the present invention, a nutritional bar containing more than 25% more protein than a standard high protein bar can be made without a substantial change in the firmness profile of the bar.

To further investigate the effects of increasing the extruded protein content of a high protein bar, a bar was formulated to contain 40% protein, 10% plasticizer, and 50% sweetener. The protein ingredient comprised either 75% extruded and ground protein, or 100% extruded and ground protein. The firmness of these bars was compared to a control bar containing 30% unextruded protein, 15% plasticizer and 55% sweetener.

The firmness of the bars was measured as described above, and the results are shown in FIG. 11B. As can be seen, as the extruded protein content of a high protein bar is increased to 100%, the bar dough is softer initially during mixing, and over time. Those skilled in the art will recognize that various combinations of extruded and unextruded protein which are contemplated by the present invention will result in the desired protein level and firmness profile of a given food product. The use of the extruded protein ingredient of the present invention allows for an increased protein level in bar doughs substantially without a concomitant increase in firmness over time.

### Example 13

### Model Bar System II—Effect on Bar Firmness of Various Types and Levels of Protein

To further investigate the effects of increasing the amount of extruded protein in the bar formulation, and to observe the behavior of other soy protein sources, a bar model was formulated to contain about 45% corn syrup (Cargill Clearsweet® 43/43), 19.5% high fructose corn syrup (Cargill IsoClear® 55), 25% protein ingredient and 10.5% glycerol. The hardness was measured with a Texture Technologies TA-23 analyzer with 1.27-cm hemispheric stainless steel probe. The probe penetrates the sample at 1 mm/min to a depth of 10 mm, and is then withdrawn at the same rate. The sample is held firmly to permit withdrawal resistance to be measured to measure the cohesiveness of the sample. Samples are stored until analysis at room temperature (23° C.) in closed containers equilibrated with saturated NaBr solution, at a relative humidity at room temperature of about 57%.

The following protein sources were used in the model bar product: soy protein isolates (>90% protein, dsb), sodium caseinate (>90% protein), and whey protein isolate (>90% protein, dsb).

FIG. 12 shows the firmness profiles for bars containing each of these proteins over time. Based on this information and the information in the other Examples herein, one skilled in the art could readily combine various sources of protein based on the desired protein content in the product, and on the effects of various protein sources on firmness, to achieve a desired firmness rate and level.

### Example 14

### Comparison of Extruded and Ground Soy Protein Isolate to Commercial (unextruded) Soy Protein Isolate in Bar Products

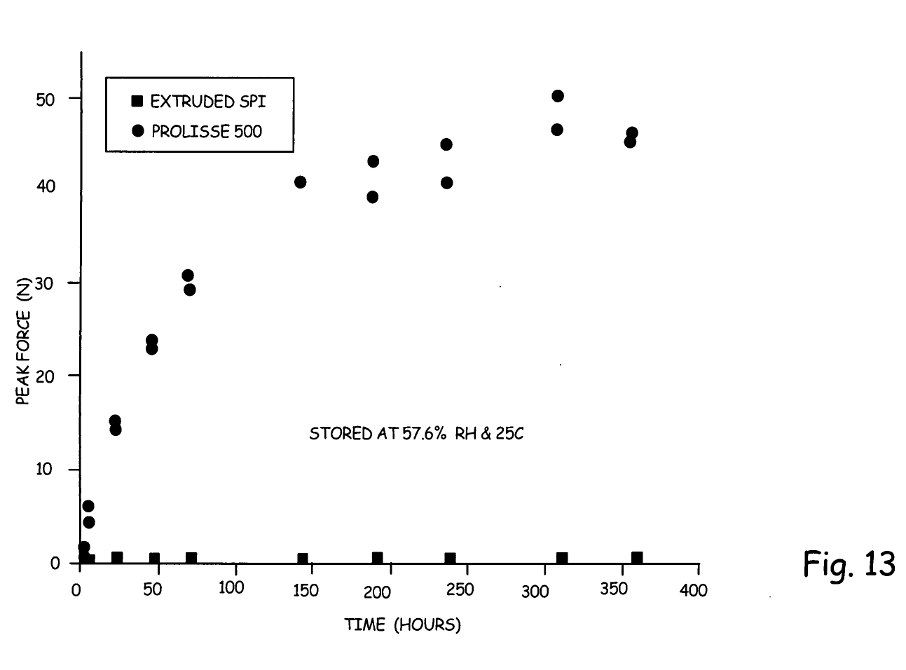

Using the protocol described in the previous Example, bar products were formulated containing either extruded and ground soy protein isolate, or standard, unextruded soy protein isolate. The results are shown in FIG. 13. The products containing extruded and ground soy protein isolate remained fluid over the study period. The products containing unextruded soy protein isolate, on the other hand, reached an unacceptable hardness level (greater than 30N) in about 3 days.

Because some degree of firmness is desired in bar and other products, the extruded soy protein isolate was blended with unextruded soy protein isolate to optimize the firmness in bar products, using the protocol described in the previous Example.

For a bar containing 25% by weight protein ingredient, 6.25% of the formula total was extruded soy isolate and 18.25% of the formula total was unextruded soy protein isolate. Another bar was prepared containing 40% extruded and ground soy protein isolate (with a corresponding decrease in the syrup level) to produce a high protein bar.

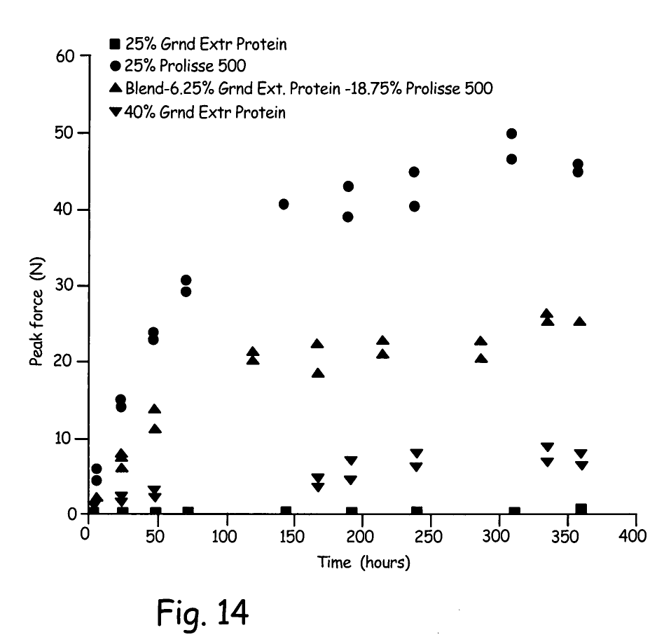

FIG. 14 shows the results of varying the levels of extruded soy protein isolate to achieve a balanced firmness desired for some bar products. Both bar formulations demonstrated an acceptable firmness level and rate.

In some instances, the appearance of the extruded and ground protein in the bar product was not optimal, so additional blends were formulated to include monocalcium phosphate to improve the color. The monocalcium phosphate was either extruded with the soy protein isolate, or was dry blended (without extrusion) with soy protein isolate. The following blends listed in Table 13 were prepared (all percentages given by weight percent of bar dough formula):

TABLE 13
Protein Blends (Wt-%)

| Ingredient | Blend 1 | Blend 2 | Blend 3 | Blend 4 |
|---|---|---|---|---|
| Extruded and Ground SPI | 23 | 37 | 6.25 | 20 |
| with Monocalcium Phosphate | 2 | 2 | — | — |
| Monocalcium Phosphate | — | — | 2 | — |
| Unextruded SPI | — | — | 16.75 | 5 |

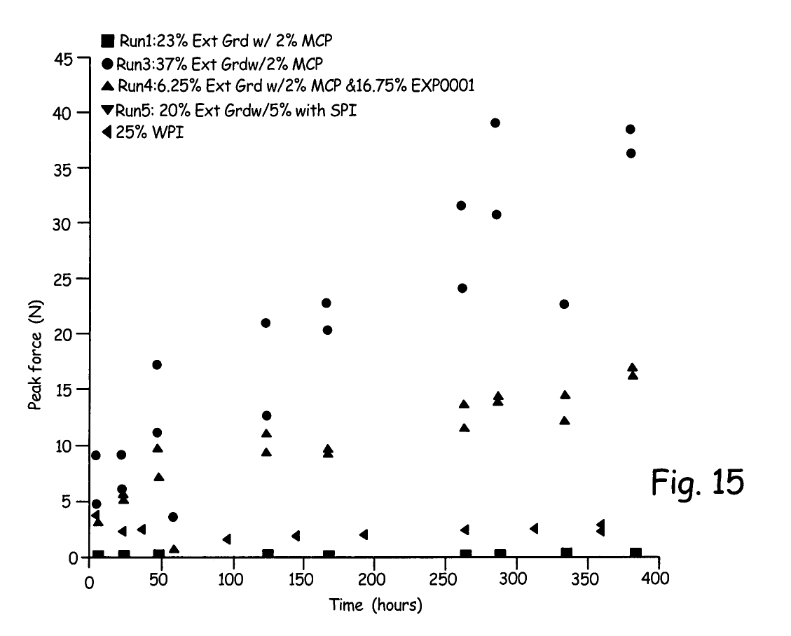

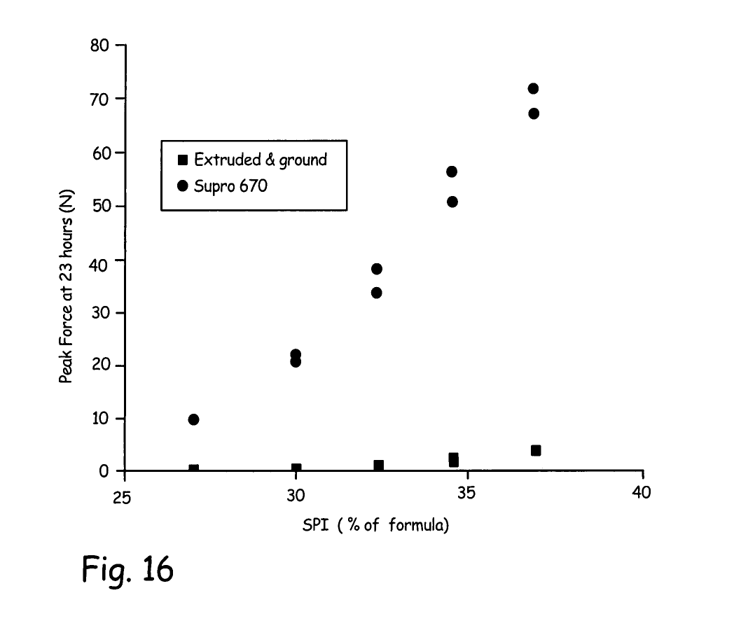

In addition, a bar product containing 25% by weight whey protein isolate was analyzed. The results are shown in FIG. 15. Again, it will be understood by those of skill in the art that by blending extruded and unextruded protein sources, an optimal firmness profile for a product can be achieved in accordance with the present invention.

### Example 15

### High Protein Nutritional Bar

To make high protein bars containing more than 25% by weight protein, 80% protein crisps were produced by extruding a mixture comprising about 90% soy protein isolate and 10% rice flour, which were then ground to a fme powder. Different weights of this material were mixed with 16 g of a syrup comprising 60% wt/wt Clearsweete 43/43 corn syrup, 26% wt/wt Isoclear® 55 high fructose corn syrup and 14% w/w anhydrous glycerol. The mixtures were placed in plastic cups, covered and stored at 57% relative humidity at room temperature. After 23 hours, the hardness of the mixtures was measured as described in Example 13.

For comparison, a mixture of Supro® 670 soy protein isolate (a product that is often used in nutrition bars and in extrusion to produce extruded protein crisps) and rice flour was prepared that matched the protein composition of the extruded crisps. A set of samples matching the concentrations of extruded and ground SPI was prepared, stored and tested alongside the extruded and ground samples.

As FIG. 16 illustrates, even at higher SPI concentrations, the extruded and ground product is significantly softer than the unextruded powdered SPI.

### Example 16

### High Fiber and Protein Bars

The extruded and ground combination of Example 9 comprising 70% soy fiber and 30% soy protein isolate was incorporated into the bar model system of Example 13. Samples from 7 to 11 g were weighed out and mixed with 16 g of a syrup comprising 60 wt % Clearsweet® 43/43, 26wt % Isoclear® 55, and 14wt % anhydrous glycerol. After mixing, the model doughs were stored 21 hours at room temperature and 57% relative humidity before measurement as described in Example 13. Comparable samples were prepared using the unextruded powdered dry ingredients that were dry blended and then weighed.

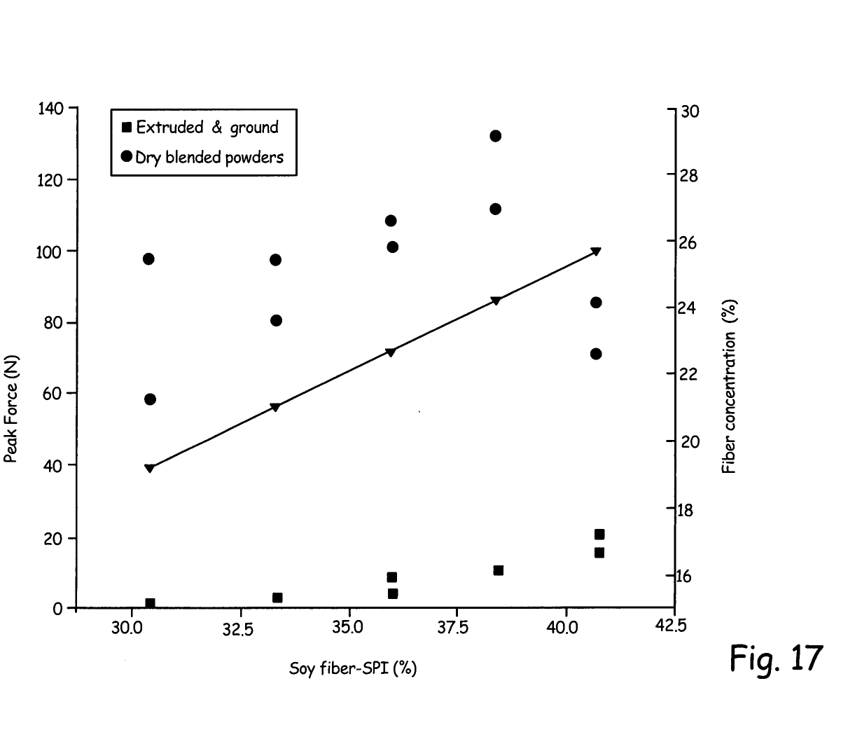

As the results in FIG. 17 show, the extruded and ground products formed soft doughs while the powdered raw materials formed very hard doughs. In fact, most of the dry powdered doughs were so non-cohesive that they would not be functional doughs in actual manufacturing. This lack of cohesion may be due to such excess syrup absorption that there was no moisture available to enable stickiness and cohesion.

A standard 50 g nutrition bar containing 20% dietary fiber (10 g) would supply 40% of the recommended amount of daily fiber intake. Made with conventional technology, this bar would be too firm to process or eat, but made with the technology of this invention would be quite manufacturable and palatable.

### Example 17

### Firming of High Fiber and Protein Bars

The extruded and ground combination of Example 9 comprising 70% soy fiber and 30% soy protein isolate was incorporated into the bar model system of Example 13. A second protein-fiber combination was prepared by extruding a mixture comprising 70% soy protein isolate and 30% oat fiber (Canadian Harvest) and grinding the resulting product. This was also incorporated into the bar model system of example 13. Samples (6.25 g) were weighed out and mixed with 18.75 g of a syrup comprising 60 wt % Clearsweet 43/43, 26wt % Isoclear 55, and 14wt % anhydrous glycerol. After mixing, the model doughs were stored at room temperature and 56% relative humidity before measurement as described in Example 13. Comparable samples were prepared using the unextruded powdered dry ingredients that were dry blended then weighed before mixing with syrup.

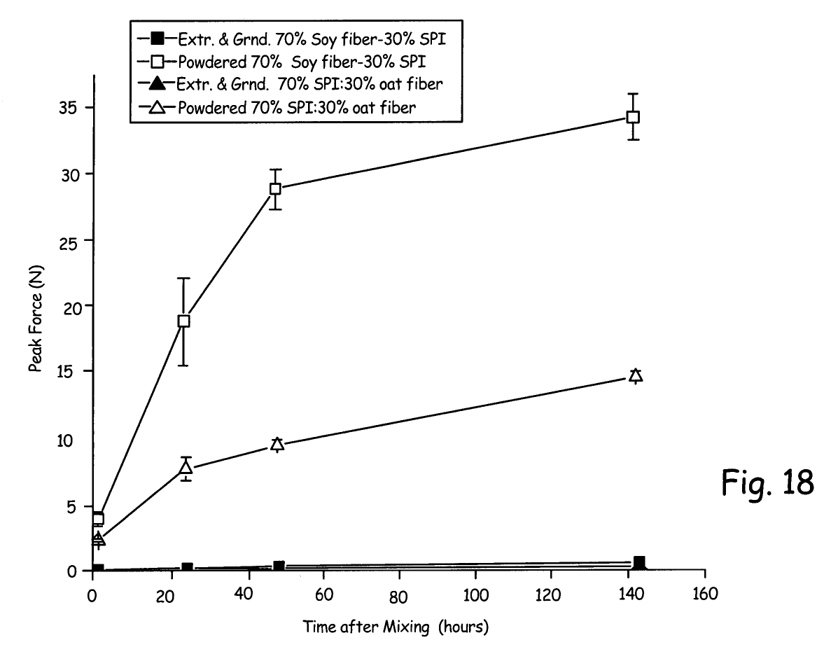

As FIG. 18 shows, the powdered combinations of SPI and fiber firmed extensively compared to the extruded and ground combinations. The extruded and ground combinations remained flowable, while the bars containing the same levels of unextruded nutrients surpassed the acceptable firmness level at about 120 hours after mixing (in FIG. 18, the plots of the extruded ingredients overlapped). It is also noteworthy that the initial firmness right after mixing of the extruded and ground combinations was much softer than the powdered combinations. This indicates that the mixing would be much easier using the extruded and ground materials.

### Example 18

### Extrusion of Fiber Ingredients

The following fiber or fiber and protein ingredients were analyzed for various parameters before and after extrusion. The results are summarized in Tables 14 and 15, and the protocols used to obtain the results are described herein.

Sample 1: 70% wheat bran+30% gelatin

Sample 2: 70% soy fiber+30% starch

Sample 3: 70% pectin+30% whey

Sample 4: 65% cottonseed+35% inulin

Sample 5: 100% precooked corn bran

Sample 6: 90% beta-glucan+10% soy protein isolate

Sample 7: 100% whole wheat flour

Sample 8: 70% soy fiber+30% soy protein isolate

All Figures below are given as percent differences from the unextruded Sample [(extruded value−control value)/control value×100].

TABLE 14
Summary of Analysis of Samples 1-8 Before and After Extrusion

| | | ΔTotal | | |
|---|---|---|---|---|
| | | Dietary | ΔInsoluble | ΔSoluble |
| Sample | Δ a_{w} | Fiber % | Fiber % | Fiber % |
| 1 | −43.0 | 9.5 | −39.9 | 87.3 |
| 2 | −60.5 | 6.1 | 6.1 | 0 |
| 3 | −9.8 | 0 | 5.3 | −18.8 |
| 4 | −54.2 | −7.4 | −8.5 | 23.8 |
| 5 | −41.0 | 7.7 | −1.5 | 89.0 |
| 6 | −34.4 | 3.3 | 85.9 | −17.85 |
| 7 | −76.2 | 6.9 | 0 | 33.0 |
| 8 | −35.6 | n/a | n/a | n/a |

As can be seen in Table 14, all of the samples showed a decrease in water activity after extrusion, thereby evidencing a possible decrease in overall hydrophilicity of the extruded fiber-protein ingredient.

In accordance with one embodiment of the present invention, the extruded and ground fiber ingredient has a water activity that is lower than the control water activity of the unextruded fiber ingredient. Preferably the water activity of the extruded and ground fiber ingredient is at least about 5% lower than the control water activity, more preferably at least about 10% lower than the control water activity, and even more preferably at least about 30% lower than the control water activity.

Table 14 also shows an overall increase of the dietary fiber content of most of the carbohydrates upon extrusion. In some cases, only one of the insoluble or soluble dietary fiber increased upon extrusion, but there clearly was an increase at some level in the available fiber component in these samples upon extrusion as compared to an unextruded sample. The fiber content was determined by the Association of Analytical Communities (AOAC) method 991.43 (Total Dietary Fibers in Foods.)

In accordance with one embodiment of the present invention, the total dietary fiber content of the extruded and ground fiber ingredient is at least about 3% greater than the control total dietary fiber content of the unextruded fiber ingredient, preferably at least about 7% greater, and more preferably at least about 10% greater than the control dietary fiber content.

The insoluble fiber content of the extruded and ground compositions of one embodiment of the present invention is at least about 5% greater than the control insoluble fiber content of the unextruded fiber ingredient. The soluble fiber content of the extruded and ground compositions of one embodiment of the present invention is at least about 20% greater, preferably at least about 50% greater, than the control soluble fiber content of the unextruded fiber ingredient.

Table 15 shows a summary of the particle density and viscosity changes that occur upon extruding the samples. The changes are shown as a percent change from the unextruded control sample.

Particle density was measured by using 2 g of each sample (in powder form) into a graduated centrifuge tube, manually tamping down the 2 g sample, and measuring the volume. In each case, the bulk density of the extruded sample was greater than the bulk density of the unextruded sample.

Viscosity was measured using a Rapid Visco Analyzer (RVA, Model RVA-4, Newport Scientific, Warriewood, Australia) as follows: a 7 g sample was weighted into an aluminum sample canister and blended manually with 15.75 g (12.5 mL) of glycerol. Water (12.5 mL) was added on top of the blend and stirred at 160 rpm at 25° C.

TABLE 15
Particle Density and Viscosity Changes Upon Extrusion
(shown as a percent change from the unextruded control sample:
[(extruded value − control value)/control value × 100]

| Sample | % Δ Particle Density | % ΔViscosity |
|---|---|---|
| 1 | 51.0 | 6844 |
| 2 | 21.4 | 533 |
| 3 | 25.2 | 0 |
| 4 | 23.8 | 82 |
| 5 | 40.4 | 612 |
| 6 | 133 | 0 |
| 7 | 33.8 | 7519 |
| 8 | 4.58 | −96 |

The particle density results demonstrate that for all the Samples, the particle density actually increased upon extrusion as compared to the unextruded fiber sample. In accordance with one embodiment of the present invention, therefore, the particle density of the extruded fiber ingredient is at least about 4% greater than the control particle of the unextruded fiber ingredient, preferably at least about 20% greater, more preferably at least about 25% greater, and even more preferably at least about 30% greater, than the control particle density.

The increase in particle density upon extrusion renders the concomitant increase in viscosity surprising, as described above. The viscosity results demonstrate that for Samples 1-7, the viscosity upon extrusion either remained the same or increased, often significantly, as compared to an unextruded sample of the same ingredient.

The increase in viscosity upon extrusion is unexpected for several reasons. First, as described above, it is unexpected that a more dense extruded particle would be able to absorb more water and become more viscous than the less dense unextruded particle. Secondly, in general, if a solid has an affinity for the liquid medium, the solid begins to swell by absorbing the liquid and the viscosity increases. In this case, the results are surprising because by some measures, the solid extruded ingredients have a demonstrated reduced hydrophilicity, and yet many of the extruded samples are capable of absorbing more water and creating a more viscous composition than the unextruded ingredient having the same composition.

While not intending to be bound by theory, it is believed that an increase in entangled domains upon extrusion may account for the increased viscosity of the extruded fiber sources as compared to the unextruded fiber sources. For example, this may be the mode of action for gel-forming fibers, such as pectin.

The viscosity of the extruded fiber ingredients of one embodiment of the present invention at about 36% moisture and 25° C. is either the same as the control viscosity, or is at least about 20% greater than the control viscosity of the unextruded fiber under the same conditions. Again, this is a surprising, unexpected result due to the reduced water activity and hydrophilicity of the extruded fiber ingredients as compared to the unextruded fiber ingredients.

The following examples demonstrate the effects of the extruded fiber ingredient in various food products.

### Example 19

### Bread Products Containing Extruded Fiber Sources

The blends analyzed above were used to make a bread product in accordance with the formula shown in Tables 16 and 17. The changes in specific volume of the bread products as compared to using unextruded fiber-protein blends, are summarized in Table 18.

TABLE 16
Bread Formula

| Ingredient | Mass (g) | Percent |
|---|---|---|
| Flour (Hummer) | 282.01 | 47.12 |
| Lecithin | 9.44 | 1.58 |
| Fiber Source | 219 | 36.59 |
| Vital Wheat Gluten | 36 | 6.02 |
| Soybean oil | 24.44 | 4.08 |
| Salt | 12 | 2.01 |
| Dough Conditioner¹ | 10.2 | 1.70 |
| Sodium stearoyl lactylate | 2.7 | 0.45 |
| Calcium stearoyl lactylate | 2.7 | 0.45 |
| Total | 598.49 | 100 |
| Yeast | 35 | |
| Water | See Table 17 | |

¹Puratos S-500 Red Dough Conditioner, Puratos, NJ

The dry ingredients were blended in a Hobart N-50 mixer for 1 minute on the low speed setting. Then water was added to the dry ingredients, and mixed for 1 minute at the low speed and for 10 minutes at the medium speed. The dough was allowed to rest for 10 minutes, then was rounded into 220 g portions and allowed to rest for another 10 minutes. The dough was sheeted to a thickness of 4 mm, then rolled into a loaf and placed in a pup loaf pan. The dough was proofed to 1 inch above the pan at 115° F. and 95% relative humidity, and baked for 19 minutes at 400° F.

The amount of water added to the dry ingredients varied, depending on the type of fiber source used and on whether the fiber source was extruded or not. Table 16 summarizes the water added to make a dough using the various fiber sources.

TABLE 17
Water Added (in grams) to Bread Formula in Table 16

| Sample | Unextruded Fiber Source | Extruded Fiber Source |
|---|---|---|
| 1 | 350 | 480 |
| 2 | 550 | 541 |
| 3 | 700 | 700 |
| 4 | 400 | 485 |
| 5 | 425 | 525 |
| 6 | 700 | 700 |
| 7 | 367 | 392 |
| 8 | 762 | 397 |

TABLE 18
Change in Specific Volume of Bread Products
using Extruded Fiber Source

| | Δ Specific Volume (% increase from |
|---|---|
| Sample | unextruded fiber source) |
| 1 | 38.5 |
| 3 | 48.4 |
| 4 | 8.2 |
| 5 | 7.0 |
| 6 | 2.7 |
| 8 | 4.19 |

In accordance with one embodiment of the present invention, bread products made with the extruded fiber ingredient of the present invention showed an increase in specific volume of at least about 2%, preferably at least about 7%, and more preferably, at least about 35%, as compared to the control specific volume of bread products made with the unextruded fiber ingredient.

### Example 20

### Bar Products Made with Extruded Fiber Sources

A model bar system similar to that in Example 10 was used with varying levels of the fiber source added to 16 g of syrup. The hardness and viscosity were measured as described in the previous examples. Hardness measurements taken at a fiber level of 36% in the bar, one hour after mixing the ingredients, are summarized in Table 19, along with a listing of the apparent viscosities of the same fiber source. The changes in hardness and viscosity are given as a percent difference from the unextruded control. As can be seen in Table 19, this embodiment of the present invention yielded an unexpected increase in viscosity of the fiber source upon extrusion while demonstrating a marked decrease in bar hardness as compared to the unextruded control fiber source.

TABLE 19
Change in Hardness and Viscosity
(shown as a percent change from the control sample [(extruded
value − control value)/control value × 100]

| | Unextruded | Extruded | | Unextruded | Extruded | |
|---|---|---|---|---|---|---|
| | Hardness | Hardness | % Δ | Viscosity | Viscosity | % Δ |
| Sample | (N) | (N) | Hardness | (cP) | (cP) | Viscosity |
| 1 | 2.915 | 0.845 | −71.012 | 360 | 25000 | 6844 |
| 2 | 55.665 | 1.285 | −97.692 | 139 | 880 | 533 |
| 3 | 1.180 | 0.170 | −85.593 | 30000 | 30000 | 0 |
| 4 | 5.695 | 8.800 | 54.522 | 1100 | 2000 | 82 |
| 5 | 4.510 | 0.195 | −95.676 | 3160 | 22500 | 612 |
| 6 | 101.270 | 2.105 | −97.921 | 30000 | 30000 | 0 |
| 7 | na | na | na | 315 | 24000 | 7519 |
| 8 | na | na | na | 10000 | 375 | −96 |

In accordance with one embodiment of the present invention, low moisture products, such as bar products, made with the extruded fiber ingredient of the present invention, demonstrate a decrease in hardness of at least about 25%, preferably at least about 50%, and more preferably at least about 70%, as compared to the hardness of bars made with the unextruded fiber ingredient.

Although the bar products have been described as being improved with respect to reduced hardness in accordance with the present invention, the present invention also encompasses other improvements in low moisture food products as a result of using the extruded ingredients described herein, such as by increasing the overall fiber content of the product, increasing the satiety index of the product, or increasing the cholesterol-modulating benefits of the product.

### Example 21

### Bulk Density Ratio and Peak Hardness

The bulk density of the fiber ingredients listed in Example 18 was measured as described below, and the ratio of the bulk density of the extruded fiber to the bulk density of the unextruded fiber was determined. The dried composition was poured into a pre-weighed plastic cup and tapped on the table top to settle the powder. Additional material was added and tapped on the table top until no more material could be added. The surface was leveled with a straight edge and the weight of the contents measured. The volume of the container was determined by filling the container with water and weighing the container.

The packed bulk density ratio is calculated as the packed bulk density of the extruded composition divided by the packed bulk density of the untreated composition. The bulk density ratios were compared to the ratio of peak hardness of the bar model containing 33% by weight extruded fiber to the peak hardness of the bar model containing 33% by weight unextruded fiber ingredient.

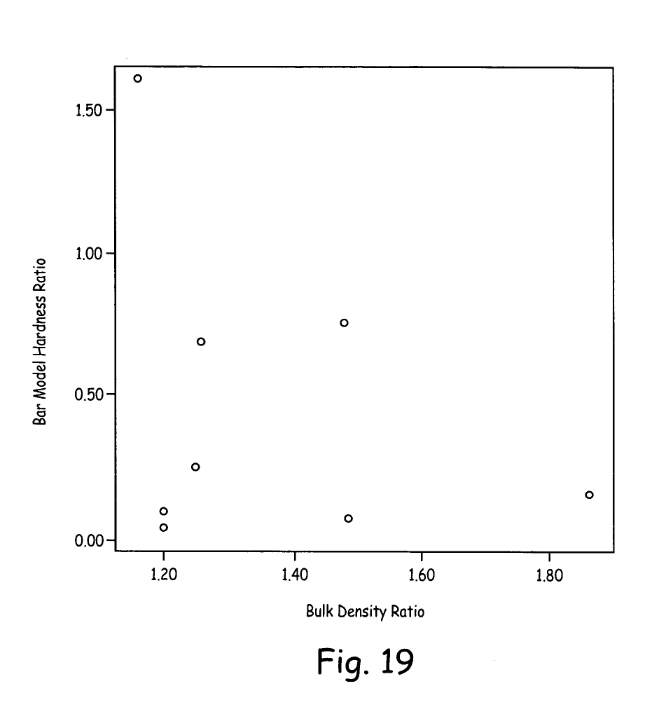

FIG. 19 shows the relationship between the packed bulk density ratio as measured above and the ratio of peak hardness of the bar model, measured using the techniques in Example 10, containing 33% w/w extruded ingredient to the bar model containing 33% w/w untreated materials.

The least effect of extrusion and grinding was observed when the packed bulk density ratio was lowest. Above that packed bulk density ratio, bar hardness was reduced moderately (25-30%) to very significantly (80-99).

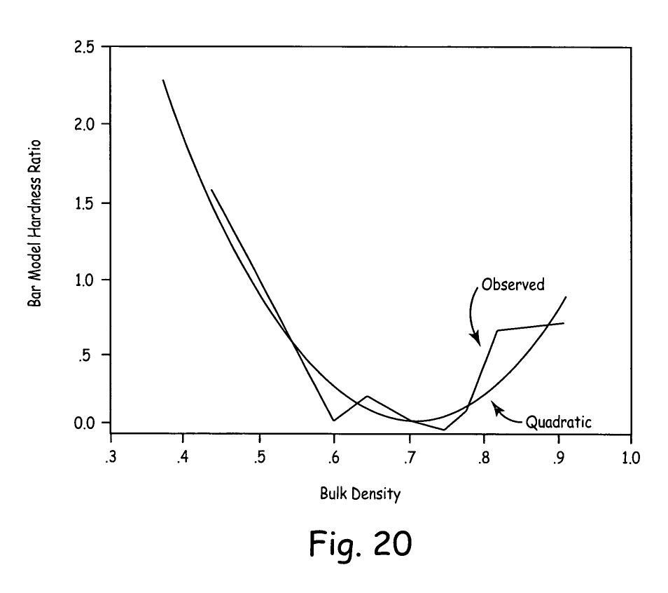

Statistical analysis shows that there is no significant (α<0.05) relationship between the two measures. A relationship was observed between the bar model ratio and the packed bulk density of the extruded composition. This is shown in the ANOVA table (Table 20) below and graph of the model shown in FIG. 20.

TABLE 20
Analysis of Variance:

| | DF | Sum of Squares | Mean Square |
|---|---|---|---|
| Regression | 2 | 1.8246102 | .91230510 |
| Residuals | 5 | .2152147 | .04304294 |
| F = | 21.19523 | Signif F = | .0036 |

Variables in the Equation

| Variable | B | SE B | Beta | T | Sig T |
|---|---|---|---|---|---|
| PACKBD | −27.786610 | 4.473361 | −7.548070 | −6.212 | .0016 |
| PACKBD**2 | 19.680154 | 3.316624 | 7.210520 | 5.934 | .0019 |
| (Constant) | 9.881641 | 1.471216 | | 6.717 | .0011 |

Particles may absorb water or other components from the syrup and swell as a consequence. Particles that swell more will occupy greater volume fractions, decrease the free syrup further and result in harder dough. Conversely, particles that swell more will be better plasticized and consequently softer at any temperature. Samples weighing 1.5 g were completely mixed with 6 mL water, after which an additional 6 mL water were mixed in and left to incubate overnight at room temperature. Samples were then centrifuged to form a solid pellet and the volume change measured.

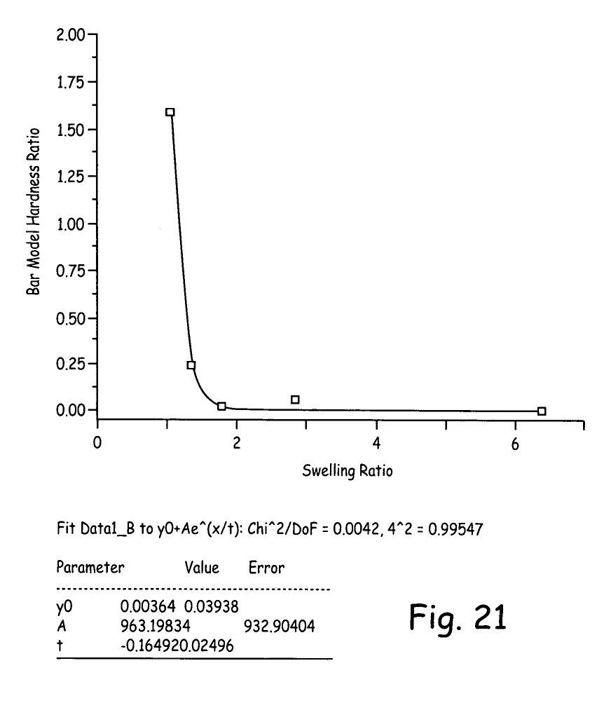

The ratio of the volume change of the extruded and ground ingredient was divided by the volume change of the untreated ingredient. The graph in FIG. 21 shows the relationship between the swelling ratio as measured above and the ratio of peak hardness of the bar model containing 33% w/w extruded ingredient to the bar model containing 33% w/w untreated materials.

While not intending to be bound by theory, it is believed that by being capable of absorbing more plasticizer and swelling, the composition itself becomes softer and thus contributes a softer aspect to the whole food formulation.

Although the reduction in firmness has been described above for bar products, the present invention encompasses the use of the altered protein, fiber, or protein and fiber ingredient of the present invention in any low moisture, high protein or fiber food product, such as, but not limited to, cookies, crackers, chips, snacks, pasta protein additives, breakfast cereals, and the like.

Although the foregoing embodiments have fully disclosed and enabled the practice of the present invention, they are not intended to limit the scope of the invention, which is fully set forth in the claims below.

What is claimed is:

1. A nutrient delivery system for a food product, comprising a fiber source, wherein the fiber source has been extruded and ground to produce an extruded and ground fiber source, and wherein the extruded and ground fiber source has a resulting water activity that is lower than a water activity of the fiber source prior to being extruded and ground.

2. The nutrient delivery system of claim 1, wherein the resulting water activity is at least about 10% lower than the water activity of the fiber source prior to being extruded and ground.

3. The nutrient delivery system of claim 1, wherein the resulting water activity is at least about 30% lower than the water activity of the fiber source prior to being extruded and ground.

4. The nutrient delivery system of claim 1, wherein the extruded and ground fiber source has a resulting total dietary fiber content that is greater than a total dietary fiber content of the fiber source prior to being extruded and ground.

5. The nutrient delivery system of claim 1, wherein the extruded and ground fiber source has a resulting viscosity at 36% moisture and 25° C. that is greater than a viscosity of the fiber source prior to being extruded and ground.

6. The nutrient delivery system of claim 1, wherein the system is capable of imparting to a bakery product made from the extruded and ground fiber source a resulting specific volume that is greater than a specific volume of a bakery product made from the fiber source that has not been extruded and ground.

7. The nutrient delivery system of claim 1, wherein the system is capable of imparting to a low moisture product made from the extruded and ground fiber source a resulting texture that is softer than a texture of a low moisture product made from the fiber source that has not been extruded and ground.

8. A nutrient delivery system for a food product, comprising a fiber source, wherein the fiber source has been extruded and ground to produce an extruded and ground fiber source, and wherein the extruded and ground fiber source has a resulting entangled domain that is greater than an entangled domain of the fiber source prior to being extruded and ground.

9. The nutrient delivery system of claim 8, wherein the extruded and ground fiber source has a resulting viscosity at 36% moisture and 25° C. that is greater than a viscosity of the fiber source prior to being extruded and ground.

10. The nutrient delivery system of claim 8, wherein the system is capable of imparting to a bakery product made from the extruded and ground fiber source a resulting specific volume that is greater than a specific volume of a bakery product made from the fiber source that has not been extruded and ground.

11. The nutrient delivery system of claim 8, wherein the system is capable of imparting to a low moisture product made from the extruded and ground fiber source a resulting texture that is softer than a texture of a low moisture product made from the fiber source that has not been extruded and ground.

12. A nutrient delivery system for a food product, comprising a fiber source, wherein the fiber source has been extruded and ground to produce an extruded and ground fiber source, and wherein the extruded and ground fiber source has a resulting particle density that is greater than a particle density of the fiber source prior to being extruded and ground.

13. The nutrient delivery system of claim 12, wherein the extruded and ground fiber source has a resulting viscosity at 36% moisture and 25° C. that is greater than a viscosity of the fiber source prior to being extruded and ground.

14. The nutrient delivery system of claim 12, wherein the system is capable of imparting to a bakery product made from the extruded and ground fiber source a resulting specific volume that is greater than a specific volume of a bakery product made from the fiber source that has not been extruded and ground.

15. The nutrient delivery system of claim 12, wherein the system is capable of imparting to a low moisture product made from the extruded and ground fiber source a resulting texture that is softer than a texture of a low moisture product made from the fiber source that has not been extruded and ground.
